(19) United States
(12) Patent Application Publication
(10) Pub. No.: US 2025/0063327 A1
(43) Pub. Date: Feb. 20, 2025

(54) CELLULAR USER LOCALIZATION SYSTEM: SMS SIDE-CHANNEL TIMING ANALYSIS METHOD AND APPARATUS

(71) Applicants: Northeastern University, Boston, MA (US); New York University in Abu Dhabi Corporation, Abu Dhabi (AE); Technical University of Dortmund, Dortmund (DE)

(72) Inventors: Evangelos Bitsikas, Boston, MA (US); Theodor Schnitzler, Dortmunt (DE); Christina Pöpper, Abu Dhabi (AE); Aanjhan Ranganathan, Boston, MA (US)

(21) Appl. No.: 18/741,036

(22) Filed: Jun. 12, 2024

Related U.S. Application Data
(60) Provisional application No. 63/531,433, filed on Aug. 8, 2023.
(60) Provisional application No. 63/648,883, filed on May 17, 2024.

(51) Int. Cl. H04W 4/14; H04W 24/02; H04W 64/00

(52) U.S. Cl. CPC H04W 4/14; H04W 24/02; H04W 64/00

(57) ABSTRACT

Systems, computer program products, and methods are disclosed for predicting a location of a target device. A method comprises sending a short message service (SMS) to a target device, via a short message service center (SMSC); receiving, from the target device and through the SMSC, a delivery report; providing the delivery report as an input to a pretrained machine learning model; deriving one or more fingerprints from the delivery report, thereby creating a target data model based on the one or more fingerprints; predicting, based on the target data model, a location of the target device.

### RELATED APPLICATION(S)

This application claims the benefit of priority to U.S. Provisional App. No. 63/531,433, filed Aug. 8, 2023; and U.S. Provisional App. No. 63/648,883, filed May 17, 2024; both of which are incorporated herein by reference in their entireties.

### GOVERNMENT SUPPORT

This invention was made with government support under Grant Number 2144914 awarded by the National Science Foundation. The Government has certain rights in the invention.

### BACKGROUND OF THE DISCLOSURE

The location-based services (LBS) market has been experiencing steady growth in recent years due to the increasing adoption of smartphones, the expansion of 5G networks, and the rise of location-aware applications.

### SUMMARY

Systems and methods are directed towards globally localizing cellular network users.

In an embodiment of the present disclosure, a method comprises sending a short message service (SMS) to a target device, via a short message service center (SMSC); receiving, from the target device and through the SMSC, a delivery report; providing the delivery report as an input to a pretrained machine learning model; deriving one or more fingerprints from the delivery report, thereby creating a target data model based on the one or more fingerprints; predicting, based on the target data model, a location of the target device.

In some embodiments, the delivery report is triggered by receipt of the SMS at the target device.

In some embodiments, the delivery report comprises one or more delays from the target device.

In some embodiments, the one or more delays comprise a processing delay, a routing delay, and/or a propagation delay.

In some embodiments, the trained machine learning model is an artificial neural network.

In some embodiments, the artificial neural network is a multilayer perceptron classifier.

In some embodiments, the one or more fingerprints comprise a time delay based on the target device location.

In some embodiments, the method further comprises sending a plurality of SMSs to the target device from a plurality of locations.

In some embodiments, the target device location is stationary.

In some embodiments, the target device location is dynamic.

In some embodiments, the pretrained machine learning model is trained on a dataset of fingerprints of known locations of target devices.

In an alternative embodiment, a system comprises a short message service center (SMSC); and a mobile device, wherein: the mobile device is configured to receive a short message service (SMS) from the SMSC; the mobile device is configured to send a delivery report based on the sent SMS to the SMSC; the SMSC is configured to receive the delivery report; the SMSC is configured to provide the delivery report as an input to a pretrained machine learning model; the pretrained machine learning model is configured to deriving one or more fingerprints from the delivery report, thereby creating a target data model based on the one or more fingerprints; the pretrained machine learning model is configured to predict, based on the target data model, a location of the target device.

In an alternative embodiment, a computer program product comprises a computer readable storage medium having program instructions embodied therewith, the program instructions executable by a processor to cause the processor to perform a method comprising sending a short message service (SMS) to a target device, via a short message service center (SMSC); receiving, from the target device and through the SMSC, a delivery report; providing the delivery report as an input to a pretrained machine learning model; deriving one or more fingerprints from the delivery report, thereby creating a target data model based on the one or more fingerprints; predicting, based on the target data model, a location of the target device.

### BRIEF DESCRIPTION OF THE DRAWINGS

The accompanying drawings, which are incorporated into and constitute a part of this specification, illustrate various exemplary embodiments and together with the description, serve to explain the principles of the disclosed embodiments.

FIG. 1 is a schematic representation of the SMS process.

FIG. 2 is a schematic representation of an attacker using an SMS stream from multiple locations, in accordance with one or more embodiments of this disclosure.

FIG. 3 is a series of bar charts indicating accuracy by device, in accordance with one or more embodiments of this disclosure.

FIG. 4 is a series of cluster graphs illustrating accuracies across numbers of classes, in accordance with one or more embodiments of this disclosure.

FIG. 5 is a series of graphs illustrating relative improvement over a number of classes, in accordance with one or more embodiments of this disclosure.

FIG. 6 is a series of boxplots between the single-senders and the enhanced multi-sender approaches, in accordance with one or more embodiments of this disclosure.

FIG. 7 illustrates single-sender accuracy trend plots for each device, per number of classes, in accordance with one or more embodiments of this disclosure.

FIG. 8 illustrates accuracy trend plots per number of classes for two and three senders, in accordance with one or more embodiments of this disclosure.

FIG. 9 is a flow diagram illustrating a method for predicting a location of a target device, in accordance with one or more embodiments of this disclosure.

FIG. 10 is an illustration of an extended version of 4G/LTE and 5G standalone architectures for the SMS procedure, in accordance with one or more embodiments of this disclosure.

FIG. 11 illustrates various delays for an SMS transmission between two users, in accordance with one or more embodiments of this disclosure.

FIG. 12 is an exemplary network flow for SMS transmissions in different locations.

FIG. 13 is an exemplary schematic of a classification methodology, in accordance with one or more embodiments of this disclosure.

FIG. 14 illustrates components and stages of the SMS location identification attack, in accordance with one or more embodiments of this disclosure.

FIG. 15 is a series of box plots depicting the timing difference in the dataset between GR, DE, DK, UK, and US locations, in accordance with one or more embodiments of this disclosure.

FIG. 16 is a series of confusion matrices for the overseas-vs.-domestic and country-based classifications, in accordance with one or more embodiments of this disclosure.

FIG. 17 is a graph illustrating the impact of these factors can be seen for operators E and F, in accordance with one or more embodiments of this disclosure.

FIG. 18A is a graph illustrating accuracy trends of the DE4-NL2 classification for various operators and devices until 35 days from the model training, in accordance with one or more embodiments of this disclosure.

FIG. 18B is a graph illustrating accuracy trends of the DE4-NL4 classification for various operators and devices until 35 days from the model training, in accordance with one or more embodiments of this disclosure.

FIG. 19 shows the classification accuracy for two victim phones with one operator (G) throughout the entire week, in accordance with one or more embodiments of this disclosure.

FIG. 20 is a schematic showing a model performance for different time windows using four phones with three different operators, in accordance with one or more embodiments of this disclosure.

FIG. 21 is a series of delivery time plots based on different times of the day for DE locations (Operator G), in accordance with one or more embodiments of this disclosure.

FIG. 22 is a series of delivery time plots based on different times of the day for DE locations (Operator E), in accordance with one or more embodiments of this disclosure.

FIG. 23 is a series of delivery time plots based on different times of the day for DE locations (Operator F), in accordance with one or more embodiments of this disclosure.

FIG. 24 shows the average classification accuracy for all pairs of locations in these three countries, in accordance with one or more embodiments of this disclosure.

FIG. 25 illustrates the probabilities (per row) for fixed and area classifications in AE, DE, and GR with three distinct SMS transmissions, in accordance with one or more embodiments of this disclosure.

FIG. 26 illustrates a series of delivery timings across different operators in various countries, in accordance with one or more embodiments of this disclosure.

FIG. 27 shows the IMS registration state prior to sending the SMS texts, in accordance with one or more embodiments of this disclosure.

FIG. 28 illustrates an active device that sends an SMS through IMS (with LTE), in accordance with one or more embodiments of this disclosure.

FIG. 29 illustrates the successful delivery of the SMS text (“sent” notification) and the wait-list for the Delivery Report, in accordance with one or more embodiments of this disclosure.

FIG. 30 depicts the reception of the Delivery Report, in accordance with one or more embodiments of this disclosure.

FIG. 31 is an exemplary computing node.

### DETAILED DESCRIPTION

Reference will now be made in detail to the exemplary embodiments of the present disclosure, examples of which are illustrated in the accompanying drawings. Wherever possible, the same reference numbers will be used through-out the drawings to refer to the same or like parts.

The systems, devices, and methods disclosed herein are described in detail by way of examples and with reference to the figures. The examples discussed herein are examples only and are provided to assist in the explanation of the apparatuses, devices, systems, and methods described herein. None of the features or components shown in the drawings or discussed below should be taken as mandatory for any specific implementation of any of these devices, systems, or methods unless specifically designated as man-datory.

Also, for any methods described, regardless of whether the method is described in conjunction with a flow diagram, it should be understood that unless otherwise specified or required by context, any explicit or implicit ordering of steps performed in the execution of a method does not imply that those steps must be performed in the order presented but instead may be performed in a different order or in parallel.

As used herein, the term “exemplary” is used in the sense of “example,” rather than “ideal.” Moreover, the terms “a” and “an” herein do not denote a limitation of quantity, but rather denote the presence of one or more of the referenced items.

The disclosed subject matter may include any of the following features among others, in various embodiments.

The disclosed subject matter may include stealthy side-channel utilization. The disclosed subject matter introduces a novel and unconventional approach by exploiting the silent SMS messages as a stealthy side-channel for user localization. Unlike traditional methods that rely on explicit location-sharing or GPS data, this system harnesses the inherent characteristics of SMS and its delivery reports to achieve accurate localization with/without the user's knowledge or consent.

The disclosed subject matter may include timing-based analysis for user localization. Existing methods often employ explicit location data or require user cooperation, which may compromise privacy. In contrast, embodiments of the present disclosure utilize timing-based analysis of SMS delivery reports, a highly innovative technique that infers user location by measuring the time it takes for delivery reports to reach the sender.

The disclosed subject matter may include machine learning-driven location prediction. The disclosed subject matter incorporates cutting-edge Machine Learning (ML) techniques to enhance the accuracy of user localization. By training a deep learning model on extensive datasets of timing measurements from typical receiver locations, unexpected levels of precision in determining the SMS recipient's multiple locations are achieved, especially for international localization. This ML-driven aspect substantially improves the localization process.

The disclosed subject matter may include global user localization capabilities. Unlike many existing methods that may be limited to specific regions or networks, embodiments of the present disclosure enable global user localization in cellular environments.

The disclosed subject matter may include non-invasive privacy-preserving solutions. The disclosed subject matter pioneers a non-invasive privacy-preserving solution for user localization. By merely analyzing existing SMS communication and delivery reports, these systems avoid the need for additional invasive tracking methods that may raise ethical concerns or require users to actively participate in location-sharing (only the mobile number is known). This novel aspect ensures that the system respects user privacy while still offering accurate and reliable localization results.

The disclosed subject matter may offer a cost-effective alternative to traditional user localization methods. By leveraging the existing SMS infrastructure and delivery reports, the need for costly specialized equipment, base stations, or network sniffers is eliminated. Users can employ the system with minimal investment, using only a computer and an Android device running coding scripts, making it financially feasible for individuals, organizations, and businesses alike.

The disclosed subject matter may operate independently of the internet, eliminating the need for constant connectivity. Unlike some existing methods that heavily rely on real-time internet access to track user locations, the system's reliance on SMS communication and timing analysis allows it to function seamlessly even in areas with limited or no internet connectivity. This feature makes embodiments of the present disclosure particularly valuable in remote or underserved regions where internet access may be intermittent or unavailable, ensuring continuous and reliable user localization capabilities.

The disclosed subject matter may include efficient and scalable global localization. Existing localization methods may face limitations in terms of scalability and global coverage. However, embodiments of the present disclosure overcome these challenges by utilizing Machine Learning (ML) techniques to train a deep learning model on timing measurements from various locations worldwide. This ML-driven approach enhances the accuracy of localization, ensuring efficient and scalable user tracking capabilities across different countries, operators, and devices.

The disclosed subject matter may include non-intrusive tracking capability. The disclosed subject matter solves the problem of intrusive tracking commonly associated with other localization methods. By operating as a passive observer of SMS communication, the need for user consent or cooperation is eliminated in the localization process. This non-invasive tracking capability is particularly beneficial in situations where explicit location-sharing may not be feasible or acceptable.

Embodiments of the present disclosure are directed to cellular communication, with a primary focus on elevating the privacy and security of SMS services. Over the years, the Short Message Service (SMS) has remained an essential method of communication within cellular networks since its inception in 2G networks. At the heart of this work lies the recognition that when an SMS is received, it triggers the generation of a delivery report, inadvertently sent back to the SMS sender. The systems may capitalize on this timing-based analysis, utilizing the inherent characteristics of SMS and its delivery report as they traverse the cellular infrastructure to create unique fingerprints from various user locations. In some embodiments, the process begins with the sender strategically sending multiple SMS messages, each generating fingerprints for desired user locations. These fingerprints rely on diverse metrics of the network's Round-Trip Time (RTT) during the SMS procedure. Accumulating an extensive dataset of fingerprints, the power of machine learning techniques is harnessed to train a sophisticated deep learning model, capable of accurate location prediction. Once the training is complete, any user equipped with this innovation can seamlessly utilize it for location identification. When the sender desires to know the current location of a user, probing SMSs are sent, and the deep learning model instantly predicts the location.

Some embodiments of the present disclosure use SMS as a medium for location identification. Some embodiments leverage conventional and easily accessible services for localization in cellular networks. The low requirements democratize system usage, making it available not only to operators, federal agencies, organizations, and businesses but also to regular network users. Embodiments of the present disclosure highlight localization-enhancing technologies in cellular communication, offering also new perspectives on security, confidentiality and user privacy in the telecommunication ecosystem.

Furthermore, the technology of some embodiments of the present disclosure may enable businesses to deliver highly targeted marketing and advertising campaigns. By reaching the right audience with personalized content, businesses can achieve better conversion rates and maximize their return on investment (ROI) in advertising and promotional activities. This targeted approach enhances customer engagement and satisfaction, fostering increased customer loyalty and potential word-of-mouth referrals. Overall, early adoption can provide businesses with a competitive differentiation in the market. Offering more accurate and efficient user localization than competitors enables companies to stand out in the location-based services industry, attracting more customers and gaining a competitive edge in their respective markets.

An application for embodiments of this disclosure lies in the realm of location-based services (LBS), cybersecurity and geospatial analytics. By leveraging the accurate and privacy-preserving user localization capabilities of embodiments of the present disclosure, companies can offer highly targeted and personalized location-based services to their customers. These services may include location-specific advertisements, optimized navigation and routing, proximity-based alerts and notifications, and location-driven data analytics for businesses. The ability to efficiently and accurately track users' locations opens up new opportunities for businesses to enhance customer engagement, optimize marketing strategies, and improve overall user experience. Moreover, applications in emergency response and disaster management scenarios could also present lucrative opportunities for government and public safety agencies, ensuring efficient and effective crisis response operations.

In the context of a cellular network, three entities are considered: the sender (SMS originator), the network (front-haul and back-haul), and the receiver (SMS recipient). The main objective is for the sender to identify the location of the receiver in real-time. The SMS procedure involves sending individual SMS messages through the network to reach the recipient's smartphone. Upon successful delivery, the recipient's device sends back a delivery report. The originator can send multiple SMSs to get an equal number of delivery reports from a recipient located anywhere in the world (as long as the recipient has cellular network access). It should be noted that the sender needs to know the mobile number of the recipient beforehand. The SMS can be silent, meaning that there is no included text and no notification in the user device, thus the recipient is not aware that the device is involved in this process. The exact formation of the silent SMS in hexadecimal is: new byte [ ] {0x0A, 0x06, 0x03, (byte) 0xB0, (byte) 0xAF, (byte) 0x82, 0x03, 0x06, 0x6A, 0x00, 0x05}.

### Measurement Collection

To achieve user localization, the sender initiates the process by sending a significant number of SMS messages to different potential locations where the receiver may be. Once the sender confirms the successful delivery, each SMS exchange is used to calculate the associated timing metrics. To achieve this the sender needs to develop an Android application running on an Android device using Telephonymanager. This application is used to send the SMS, receive the associated report and calculate the following six metrics (for each SMS exchange): (1) SMS sent time (2) SMS delivery time (3) SMS total time (4) SMS delivery time to total time ratio (5) Sent time of two consecutive SMS (current and previous) (6) Delivery time of two consecutive SMS (current and previous).

To ensure the proper automation and resilience of this process, a Python program is developed which handles the Android device via USB (with Android Debug Bridge), handles the application and programs the execution using Linux chronjobs. The application uses the device's user interface to artificially press buttons and interact with the device, and the user sets up the number of SMS to be sent per location with a specific timeframe (e.g., every 10 minutes). Eventually, the sender has the collection of SMS metrics for each location, which are processed further.

### Fingerprint Generation:

The collected metrics for each location form a unique fingerprint that characterizes the specific location. Multiple fingerprints are associated with each receiver location. To ensure data integrity, the fingerprints are meticulously categorized and refined, removing outliers (i.e., metric values which excessively deviate from normal).

### Dataset and Neural Network:

Datasets are constructed based on the desired receiver locations for investigation. The fingerprints, labeled according to their corresponding locations, are combined into a comprehensive data file for machine learning training. A neural network is employed for training and location prediction. A Python program handles the dataset formation and model handling processes, utilizing the SKlearn library for neural network construction. The neural network has the following properties: (1) Multilayer Perceptron structure (2) stochastic gradient descent solver (3) softmax for multiclass, sigmoid for binary, as activation functions (4) typically three layers with 10, 40, and 10 nodes for the input, hidden, and output layers respectively (5) maximum iterations to 5000 (6) learning rate to be constant (7) batch size to be 32 (8) alpha to be 0.0001.

The trained model can then be used by the sender for location prediction by generating new SMS metrics and utilizing the model to predict the receiver's location accurately. This is possible by sending new SMSs, generating all fingerprints and using the model to output the predicted location of the user/receiver at the time of the SMS collection.

SMS-timing-based location inference attacks leverage timing side channels to ascertain a target's location. Prior solutions have primarily relied on a single-sender approach, employing only one SMS attacker from a specific location to infer the victim's whereabouts. However, this method exhibits several drawbacks. Systematically enumerating the limitations of the single-sender approach, prompted the exploration of a multi-sender strategy. The investigation delves into the feasibility of an attacker employing multiple SMS senders towards a victim to address these limitations and introduces novel features to bolster prediction accuracy. Through exhaustive experimentation, it is demonstrated that strategically positioned multiple SMS senders significantly enhance the location-inference accuracy, achieving a 142% improvement for four distinct classes of potential victim locations.

SMS has emerged as a key vector in numerous cyber-attacks due to its widespread use for purposes such as two-factor authentication, identity verification, and emergency alerts. Its prevalence, reliability, and global reach have made it a favored medium for malicious activities. Smishing attacks, for example, leverage SMS to distribute links that direct victims to phishing sites, aiming to steal sensitive information. The Flubot virus utilized SMS links to spread trojan apps that compromised banking credentials, personal data, and disabled security features. Beyond these, SMS has been exploited for spamming and to propagate malware such as Simjacker and WIBAttack, which embed malicious commands within binary SMS messages.

An approach to ascertain the location of recipients utilizes the timing of silent SMS messages in conjunction with machine-learning techniques. This strategy exploits the delivery reports generated upon SMS reception as a timing attack vector for the sender. Rigorous experimentation across various countries, telecommunications operators, and a range of devices demonstrate that an attacker can deduce a recipient's location by analyzing timing data from typical receiver locations. Although this method introduces an innovative side channel for localizing mobile users, it encounters notable limitations. Most importantly, there is a significant probability that the attack originating from a single source/mobile device can be detected and potentially be blocked by the victim's service providers. This is more apparent when the attack requires a substantial amount of SMS transmissions to collect the necessary data. Additionally, as the number of possible victim locations increases, the method's accuracy in predicting locations degrades due to the finite entropy available from single attacker-victim channel timing reports. As a result, there are classifications in which machine learning can perform poorly.

To tackle the above-mentioned limitations associated with single-sender-based SMS location inference attacks, embodiments of the present disclosure include the following key points. The primary question is whether using multiple coordinated SMS senders can improve the accuracy of localization predictions. Using senders from different locations could create unique timing side-channels which, when combined, could lead to more accurate classifications. This multi-sender approach can improve the prediction accuracy, especially as the number of potential victim locations increases. Additionally, using multiple SMS senders spread out geographically could also make the attack more resilient against being blocked, as the victim's service provider now has to identify and block several senders. Optimizing the timing and pattern of SMS sending could further reduce the likelihood of the attack being detected. Finally, the attacker can collect a significantly smaller amount of data to conduct this attack efficiently, without compromising the model's accuracy. Consequently, the adversary can save resources, as well as measurement collection and training time.

Motivated by the above, embodiments of the present disclosure focus on the following:
Identifying limits of single-sender SMS-timing-based location inference attacks and conceiving multi(ple)-sender SMS-timing-based location inference attack in cellular networks. To establish a baseline for comparison with the multi-sender approach, the single SMS sender-based localization attack described below is reproduced. Interestingly, data analysis highlights certain limitations inherent in the single-sender approach which serve as a crucial motivation for the development of the multi-sender approach.
Through rigorous experimentation, the enhanced capability of multiple SMS senders strategically placed across different locations is demonstrated, to co-ordinate and significantly improve the accuracy in determining a victim's location. The multi-sender MMS approach can reach up to 142% accuracy improvement for four classes. This further emphasizes that the effectiveness of the multi-sender attack strategy improves with an increasing number of potential victim locations, thereby overcoming a significant limitation of the single-sender approach.
Two substantial improvements and insights are highlighted: (1) From the distinct timing side-channels generated by the multi-sender setup, new features that are instrumental in boosting the prediction accuracy are identified and introduced: the statistical mean, median, and standard deviation of the senders' delivery time measurements, allowing the effectively fusing of the timings from multiple senders to improve the accuracy even further. (2) The required sample sizes show that already a few hundred SMS can yield strong results without the need for thousands of collected messages.

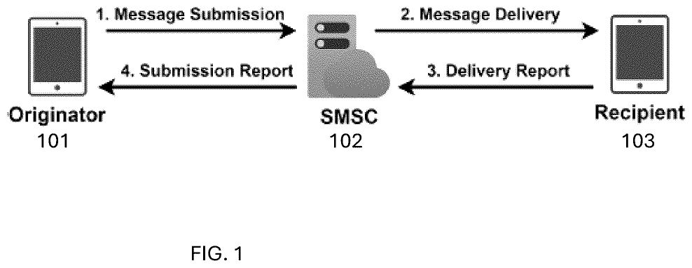

FIG. 1 is a brief representation of the SMS process 100. SMS is an inherent component of the cellular infrastructure and universally accessible across all network generations from 2G to 5G. In process 100, a message is composed and submitted from an originator 101 to a Short Message Service Center (SMSC) 102. Upon receiving the SMS, the SMSC 102 performs the necessary network and validation checks and then forwards the SMS to the intended recipient 103. The SMSC 102 ensures that the message reaches the recipient 103, even if it means storing it temporarily, in case the recipient 103 is unavailable immediately. Additionally, the originator 101 has been informed by now that the submitted message was actually sent.

Next, once the recipient 103 receives the message, the involved device sends the delivery report back to the SMSC 102. The report confirms that the message has been successfully delivered to the recipient's device. Finally, the report is sent to the originator 101 via the SMSC 102, called the submission report. This report ultimately confirms that the message was sent and delivered to the recipient 103 successfully.

In an SMS-timing-based location inference attack, an attacker is interested in learning the current physical location of a specific victim by sending them (silent) SMSs. The attack builds upon the time elapsed between sending the SMS and the SMS being delivered to the victim and is conducted in two phases.

In the first phase (fingerprint generation), the attacker repeatedly sends SMSs to the victim while knowing their respective locations and measures the time it takes to deliver the SMS messages. By analyzing the resulting delivery timings and their distributions, the attacker is able to determine a unique fingerprint for each of the locations the victim has visited.

In the second phase (location inference), the attacker sends new SMS messages to the victim without knowing their current location, measures the time it takes to deliver them, and then classifies the collected timings by comparing them to the previously obtained fingerprints. Thus, the attacker can determine and re-identify the victim's location out of a set of known locations.

When the SMS-timing-based location inference attack is carried out from a single sender at a fixed location, it has several drawbacks. In particular, the success and performance of the attack depend heavily on the specifics of the chosen location and its mobile network connection, such as the distance to the base station. The quality and reliability of the connection, along with the robustness of the collected data, may also vary depending on circumstances specific to the location, such as fluctuating numbers of people and concurrent mobile network connections throughout the day or week.

Another drawback of the single sender attack is that during the initial phase of the attack (fingerprint generation), the attacker engages in non-standard behavior as a mobile network subscriber. Consequently, there is a risk that the adversary may be perceived as suspicious by the network operator and potentially be blocked, particularly if only a single static location is utilized.

From an organizational perspective, the attack encompasses analyses at various levels of granularity, and a broad range of locations, from regional to worldwide attacks. Hence, the necessity for a more systematic evaluation of factors that could impact the SMS-timing-based location inference attack's performance are recognized. This entails varying the adversary's location, systematically assessing the attack's performance with different receiving devices at the same locations, conducting repeated evaluations with varying sample sizes, and expanding the attack to encompass attackers operating from multiple vantage points simultaneously.

### Multi-Sender Location Inference

### Threat Model

When considering an attacker whose primary goal is to determine the presence of a victim's mobile device within a specific geographic area, it is assumed the attacker does not have the intention to track the victim's exact movements.

The attacker is presumed to possess the victim's mobile number, enabling them to initiate various forms of SMS communications, including personal messages, undirected mass messages such as marketing advertisements, and notably, silent SMSs which the victim's device acknowledges without alerting the user. It is assumed that the attacker has access to an arbitrary number of smartphone devices, SIM cards, mobile numbers, and subscription plans. Furthermore, the attacker can deploy multiple sender devices in different geographical areas to collect data from the victim receivers simultaneously and combine them for location extraction. The adversary is assumed to possess the capability to utilize network services as a conventional user: leveraging several SIM cards, having the ability to send messages to any subscriber with a valid number, and maintaining a normal connection for the transmission of text messages and receipt of delivery notifications.

It is emphasized that the attacker does not require physical access to the victim's mobile device, USIM cards, or any network infrastructure, nor do they seek to obtain or modify sensitive victim data such as cryptographic keys.

### Attack Concept

The foundation of the multi-sender approach rests on the observation that fingerprints generated from the SMS exchanges between a single sender (attacker) location and a receiver can be limited in their effectiveness for accurate location classification. This limitation becomes particularly pronounced in complex environments, such as certain city locations where the variability and granularity of the urban landscape can dilute the distinctiveness of timing fingerprints.

To address these challenges, embodiments of the present disclosure pioneer the integration of multiple attacker locations into the analysis framework. By orchestrating SMS exchanges from various (unique) attacker positions to the receiver, a richer and more nuanced dataset emerges. Each unique pairing of attacker and receiver locations contributes a distinct timing fingerprint to the dataset. These timing fingerprints, when aggregated, undergo further processing to distill additional dataset features, thereby forging more robust and comprehensive fingerprints. This enriched dataset plays a crucial role in enhancing the efficacy of machine-learning models during both the training and prediction phases.

For conducting a multi-sender location inference attack, a single-sender attack methodology is replicated and simultaneously executed from multiple locations. The attack comprises two phases: fingerprint generation and location inference, but both are conducted from multiple sender locations. Basically, multiple instances of the single-sender location inference attack are executed in parallel.

### Multi-Sender Setup

To gather data from multiple vantage locations and eventually enhance the accuracy of the location identification attack, the attacker deploys the setup at various geographical locations. Intuitively, by employing more attacking locations that are diverse, an adversary could generate more precise receiver location fingerprints. This distributed approach allows the attacker to collect measurements of the victim's location from different “angles”, increasing the robustness and reliability of the subsequent analysis.

### Attacking Process

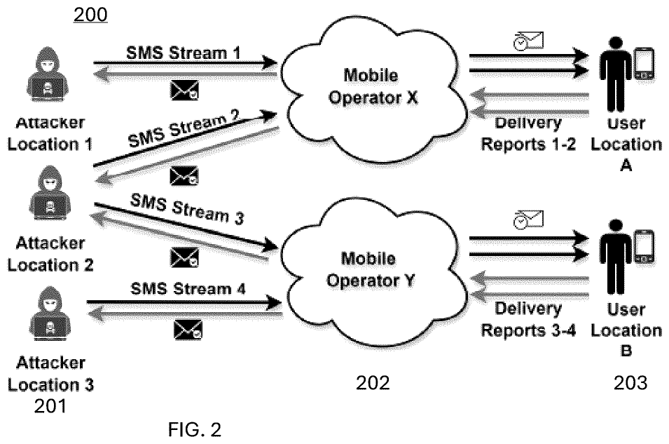

FIG. 2 illustrates an exemplary multi-sender setup 200. The attacker, situated in multiple locations 201, initiates the process by sending a barrage of silent SMS messages to the victim. The victim, unknowingly participating in this scheme, moves across different locations 203 at different times. The silent nature of these messages means that the receiver's device does not notify the victim of the incoming SMS, thus keeping the process clandestine. Each time a message is received, the victim's device automatically generates and sends back delivery reports as part of its standard operating procedure. These reports, unbeknownst to the victim, reveal valuable information for the attacker, notably the sent and delivered times. By analyzing the time discrepancies between when a message was sent and when the delivery report was received, the attacker can infer certain aspects of the victim's location.

Since this procedure is repeated multiple times in the multi-sender attack, it accumulates a substantial dataset of measurements. The attacker categorizes the measurements based on the victim's known locations during the attack, forming distinct datasets for each location. These datasets are then aggregated and analyzed to predict the victim's location in the future. As shown in FIG. 2, the attacker creates several SMS streams, which could be established with different operators 202 as the attacker can operate from different countries. The victim may also move to different countries, and sends back the delivery reports to the corresponding SMS.

In the prediction stage, the attacker collects fresh measurements from the current location of the victim in the same fashion. These measurements serve as input for a machine-learning model that has been trained on the previously collected data, representing potential locations of the victim. Then, the model processes this input and outputs a prediction of the victim's current location.

At the core of the attacker's setup is the use of typical computer devices equipped with a smartphone running Android Debug Bridge (ADB). ADB allows for a wide range of communication with a connected device, in this case, to transmit silent SMS messages and record the sent and delivered timestamps. The SMS transmission and recording of the timing metrics may be conducted by an Android application, which also stores results for further processing. It is contemplated that other suitable applications could also be used, such as iOS applications. Controlling the application via ADB allows for the automation of this process since it should be repeated multiple times to collect a sufficient number of timing metrics. This process also happens stealthily, without altering the victim, since the attacker utilizes silent SMSs which are accepted by the network operator. Moreover, the attacker's equipment includes a SIM card, granting access to the cellular network.

Adhering to the aforementioned attacking concepts, over a period of 12 weeks, SMS messages were repeatedly sent between smartphones in different locations in Germany and the Netherlands. Locations that are very far apart are easier for an attacker to identify, so the Germany and Netherlands locations were chosen to avoid this issue. Three smartphones, each placed in a fixed location that remains unchanged, were used to send messages to four phones whose positions are periodically rotated. For sending SMS messages, two locations in Germany and one in the Netherlands were utilized. The receiving phones are placed in five different locations in Germany and three in the Netherlands (including the locations of the sending devices). Table 1 lists the devices used for sending and receiving SMS messages, and Table 2 provides an overview of the locations used during the measurements and the amounts of data collected.

TABLE 1
Device Specifications

| | | | | | |
|---|---|---|---|---|---|
| ID | Device | Chipset | OS | Model | Release |

Sending Devices

| | | | | | |
|---|---|---|---|---|---|
| D | Samsung Galaxy A53 | Samsung Exynos 1280 | Android 12 | SM-A536E/DS | 2022 |
| V | Nokia 5.3 | Qualcomm Snapdragon 665 | Android 11 | TA-1234 | 2020 |
| B | Huawei P8 Lite 2017 | HiSilicon Kirin 655 | Android 8 | PRA-LX1 | 2017 |

Receiving Devices

| | | | | | |
|---|---|---|---|---|---|
| px6a | Google Pixel 6a | Google Tensor | Android 12 | G1AZG | 2022 |
| a53 | Samsung Galaxy A53 | Samsung Exynos 1280 | Android 12 | SM-A536E/DS | 2022 |
| op7 | OnePlus 7 Pro | Qualcomm Snapdragon 855 | Android 11 | GM1910 | 2019 |
| p8l | Huawei P8 Lite 2017 | HiSilicon Kirin 655 | Android 8 | PRA-LX1 | 2017 |

TABLE 2
Data Collection Summary

| Number of SMS per | | | | Distances [km] to Sender | | |
|---|---|---|---|---|---|---|
| Receiving Device | | | | Sender | Sender | Sender |
| px6a | p8l | op7 | a53 | B | D | V |

Receiver Locations in Germany

| | | | | | | | |
|---|---|---|---|---|---|---|---|
| DE-1 | 3160 | 3280 | 420 | — | 11 | 0 | 140 |
| DE-2 | 1540 | 1560 | — | — | 2 | 11 | 130 |
| DE-3 | 4960 | 4540 | 8920 | 6900 | 0 | 11 | 129 |
| DE-4 | 420 | 460 | — | — | 4 | 14 | 126 |
| DE-5 | 1220 | 320 | — | — | 5 | 11 | 140 |

Receiver Locations in the Netherlands

| | | | | | | | |
|---|---|---|---|---|---|---|---|
| NL-1 | 7140 | 5500 | 0 | 1440 | 125 | 135 | 4 |
| NL-2 | 5820 | 5280 | 10300 | 8700 | 129 | 140 | 0 |
| NL-3 | 2020 | 960 | 1680 | 1120 | 125 | 136 | 7 |

Locations (Cities):
DE-1.5; Dortmund,
DE-2,3,4: Bochum,
NL-1: Eindhoven,
NL-2: Veldhoven,
NL-3: Valkenswaard

Locations in the same country are chosen to be relatively close to each other. The distance from a receiving location to the closest sending device is 11 km at maximum, which also corresponds to the distance between the two sending devices in Germany.

The attack was replicated using an Android app that sends one silent SMS at a time to a designated target phone number. Additionally, the app waits for the Sent and Delivered notifications and collects and stores the times-tamps for the SMS transmission and both notifications. Twenty consecutive SMS transmissions were scheduled on an hourly basis. SMS transmissions were automated by controlling the app remotely via a Python script issuing ADB commands to the smart-phone. SMS messages are simultaneously sent from all senders to the same receiver by scheduling the script to start once per hour at the same time for a specific receiver (i.e., :00 for the first receiver, :15 for the second receiver, . . . ) across all senders. While this does not guarantee perfect sender synchronization due to potential offsets in their individual system clocks, this may be considered a best-effort approach to approximate the behavior of an adversary simultaneously probing a specific target from multiple locations.

To generate the timing features for each SMS transmission and combine the multi-sender datasets, the following steps are taken:

### Step 1: Calculating the Initial Metrics

Initial metrics are calculated for each SMS transmission in the collected dataset: the real sent duration Tₛₑₙₜ, the real delivery duration T_{del}, the total delivery duration Tₜₒₜ, and the delivery ratio P.

$${T}_{sent} = {t}_{sent} - {t}_{tx} \qquad ( 1 )$$

$${T}_{del} = {t}_{del} - {t}_{sent} \qquad ( 2 )$$

$${T}_{tot} = {T}_{del} + {T}_{sent} \qquad ( 3 )$$

$$P = \frac{{T}_{del}}{{T}_{tot}} = \frac{{t}_{del} - {t}_{sent}}{{t}_{del} - {t}_{tx}} \qquad ( 4 )$$

For every two consecutive SMS transmissions, (j−1 and j), the differences in sent duration T_{Δsent} and delivery duration T_{Δdel} are calculated, respectively:

$${T}_{Δ sent} = ( {T}_{sent}^{j} - {T}_{sent}^{j - 1} ) / {T}_{sent}^{j - 1} \qquad ( 5 )$$

$${T}_{Δ del} = ( {T}_{del}^{j} - {T}_{del}^{j - 1} ) / {T}_{del}^{j - 1} \qquad ( 6 )$$

The fingerprint does not conclude with this calculation, as multiple senders are considered.

### Step 2: Combining the Sender Datasets

Let Dᵢ represent the dataset for sender i, where i=1, 2, . . . , m, with n receiver locations. Additionally, let t_{del,i,r,j} denote the delivery time of the j-th SMS transmission from sender i to receiver r. Finally, let S_{i,r,j} represent the data associated with the j-th SMS transmission from sender i to receiver r, including t_{del,i,r,j}. Then, D_{concat} is the dataset resulting from the concatenation process, where each element is derived by matching S_{i,r,j} from all senders based on the closest matching t_{del,i,r,j}.

For each S_{i,r,j} in Dᵢ, S_{k,r,l} in Dₖ (k≠i) is found such that the difference in delivery times |t_{del,i,r,j}−t_{del,k,r,l}| is minimal or zero, indicating the closest matching timestamps across different senders. This process occurs for every receiver separately and every available sender, until the new D_{concat} dataset contains per row the data of each sender to the same receiver, but synchronized. Algorithm 1 shows the process:

Algorithm 1 Match and Concatenate SMS
Transmissions based on Timestamps

| | |
|---|---|
| 1: | Initialize D_{concat} = ∅ as empty dataset |
| 2: | for each receiver location r from 1 to n do |
| 3: | for each S_{i, r, j} in Dᵢ for all i do |
| 4: | Initialize a list L_{i, r} to hold data for concate- |
| | nation |
| 5: | for each Dₖ where k ≠ i do |
| 6: | Find S_{k, r, l} in Dₖ such that \|t_{del, i, r, j} − |
| | t_{del, k, r, l}\| is minimized |
| 7: | Add S_{k, r, l} to L_{i, r} |
| 8: | end for |
| 9: | NewRecord_{i, r} ← Concatenate(L_{i, r}) |
| 10: | D_{concat} ← D_{concat} ∪ {NewRecord_{i, r}} |
| 11: | Clear L_{i, r} |
| 12: | end for |
| 13: | end for |

### Step 3: Fusing the Sender Datasets Statistically

Given m senders, the number of unique combinations of two senders is given by the binomial coefficient:

$$( \begin{matrix}m \\ 2\end{matrix} ) = \frac{m !}{2 ! ( m - 2 ) !} \qquad ( 7 )$$

For each pair of senders and for every z consecutive SMS transmissions (here, z=5), the mean, median, and standard deviation of the delivery times were calculated. Let t_{del,i}^{(s,r)} denote the delivery time of the i-t SMS in a sequence of z consecutive messages from sender s to receiver r. The statistics are calculated as follows:

$${μ}^{( s , r )} = \frac{1}{z} {\sum }_{i = 1}^{z} {t}_{del , i}^{( s , r )} \qquad ( 8 )$$

$${Median}^{( s , r )} = Median \{ {t}_{del , 1}^{( s , r )} , {t}_{del , 2}^{( s , r )} , … , {t}_{del , z}^{( s , r )} \} \qquad ( 9 )$$

$${σ}^{( s , r )} = \sqrt{\frac{1}{z - 1} {\sum }_{i = 1}^{z} {( {t}_{del , i}^{( s , r )} - {μ}^{( s , r )} )}^{2}} \qquad ( 10 )$$

Differences in these statistics for the delivery time between pairs of senders are calculated as their actual differences. For example, for means between sender pair (s₁,r) and (s₂,r):

$${Δμ}^{( {s}_{1} , {s}_{2} , r )} = {μ}^{( {s}_{1} , r )} - {μ}^{( {s}_{2} , r )} \qquad ( 11 )$$

These differences, Δμ^{(s}^{₁}^{,s}^{₂}^{,r)}, ΔMedian^{(s}^{₁}^{,s}^{₂}^{,r)}, and Δσ^{(s}^{₁}^{,s}^{₂}^{,r)}, are incorporated into the dataset for each sender pair accordingly, as additional features.

### Simple Integration of Senders

In this method, the initial features are generated based on the timing data from individual sender-receiver pairings (Step 1). Subsequently, datasets corresponding to multiple senders are amalgamated (Step 2) without the application of sophisticated statistical fusion techniques (Step 3). Thus, datasets are created that are matched and concatenated based on the timestamps, but without incorporating unique feature types.

Specifically, double- and triple-sender datasets are considered as distinct (simple) approaches. For the double-sender cases, the BV, VD, and BD datasets are created, while for the triple-sender cases, the BDV is created based on Table 2. The total number of features for double-senders is 12, and for triple-senders is 18, according to the calculations from Step 1. This exploratory step seeks to discern whether straightforward sender concatenation can bolster the machine-learning model's predictive accuracy compared to single senders and to statistically combined datasets.

### Statistical Fusion of Senders

Advancing beyond the simple approach, the statistical combination of sender datasets represents a more refined approach to dataset enhancement. This technique encompasses a comprehensive process involving the generation of initial features (Step 1), the combination of sender measurements (Step 2) followed by the fusion of datasets from multiple senders through the statistical metrics (Step 3). Unlike the simple method, this approach enriches the combined dataset with additional features derived from the statistical analysis of delivery times: using the means, medians, and standard deviations between the sender measurements. For this approach, all three senders are used with their maximum sample size available for each receiver location.

Embodiments of the present disclosure utilize the following two strategies:
Enhanced Mean Datasets: Datasets statistically enhanced by the mean of the delivery time. A total number of 21 features is used, corresponding to the 18 combined features for the three senders and the three additional ones generated by the differences between the sender means.
Enhanced MMS Datasets: Datasets statistically enhanced by the mean, median and standard deviation of the delivery time. A total number of 27 features is utilized, correlated with the 18 combined features for the three senders and the nine extra ones engendered by the differences between the sender means, medians, and standard deviations.

This dual-strategy approach aims to demonstrate the superiority of statistically enhanced datasets over both single-sender datasets and those trivially combined. The inclusion of a broader array of statistical features not only increases the accuracy of location predictions beyond that achievable with simpler dataset combinations but also highlights the comparative advantage of the “Enhanced MMS” over the “Enhanced Mean” approach. This distinction underscores the principle that the depth and complexity of features within the dataset are pivotal to the refinement of model accuracy.

Embodiments of the present disclosure employ a Multilayer Perceptron (MLP) Classifier, a type of feedforward artificial neural net-work, as the core predictive model to analyze the relationship between the features derived from SMS transmission data and the target outcomes. The MLP Classifier is instantiated with a specific configuration of hyperparameters to optimize its performance for the given dataset. The architecture of the neural network is defined by hidden layer sizes=(10, 40, 10), indicating a three-layered structure where the input data is first processed by a layer of 10 neurons, followed by a denser layer of 40 neurons, and finally, the information is aggregated through a layer of 10 neurons before reaching the output layer. This configuration is designed to capture the nonlinear relationships between the input features.

The model utilizes the stochastic gradient descent (SGD) algorithm for optimizing the network's weights. This choice is motivated by SGD's efficiency in handling large datasets and its capability to escape local minima during training. The regularization term, alpha=0.0001, is set to a low value to prevent overfitting while allowing the model to learn complex patterns in the data. With learning rate=‘constant’ and a max iteration of 5000, the learning rate is kept fixed across all epochs of training, and the model is allowed a substantial number of iterations to converge towards an optimal set of weights. Batch processing is employed with a size of 32 to lever-age computational efficiency and stability in gradient de-scent updates. Model evaluation is conducted through a 10-fold cross-validation process providing a robust estimate of the model's predictive accuracy on various random data. Finally, the Accuracy metric is calculated to quantify the model's performance, offering a measure of how often the model predictions match the true labels. The model prediction is repeatedly run with increasing numbers of samples per class, (i.e., 100, 200, 300, 500, 1000, 5000, and 10000), to analyze differences in the classification accuracy.

### Single Senders: Baseline

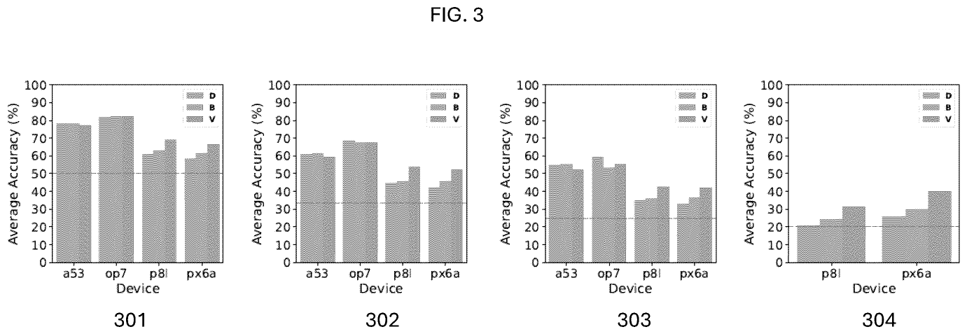

The classifications for single senders (D, B, and V) were run to establish a baseline for the subsequent improvement. FIG. 3 illustrates the results 300 of all classifications for all sample sizes in graphs 301, 302, 303, and 304. These graphs show average single-sender accuracy scores across devices and classes. These scores are considered the established baseline for which improvement is provided. The presented results take all possible sample sizes into account. The red dashed line indicates random guessing. Graph 301 illustrates scores for 2 classes, graph 302 illustrates scores for 3 classes, graph 303 illustrates scores for 4 classes, and graph 304 illustrates scores for 5 classes. Generally, the lowest accuracy is observed for sender D on the device p8l with 5 classes (21%), while the highest accuracy is observed for sender B on the device op7 with 2 classes (82%). In fact, similar observations are made for the single sender classifications, regarding the average accuracy scores and the decline across the increasing number of classes.

Specifically, for each device examined ranging from a53 to px6a, the data showcases a nuanced relationship between the number of classes involved in the classification task and the single sender accuracy scores. Notably, as the number of classes increases, a general trend of decreasing accuracy is observed, which is consistent across all devices. This trend is particularly evident when comparing results from 2-class configurations to those with 4 or 5 classes, where the average accuracy scores tend to diminish, highlighting the increased complexity and challenges associated with classifying a larger number of classes. Moreover, some devices and senders exhibit a more graceful degradation in accuracy as more classes are added. For example, V on px6a degrades from 66% with 2 classes to 40% with 5 classes, a relatively modest decline compared to D on p8l, which plummets from 61% with 2 classes to 21% with 5 classes.

In the comparative analysis of device performance, the op7 and a53 models significantly outperform the p8l and px6a devices across all metrics. In particular, the p8l and px6a devices achieve a maximum accuracy of 69% and 66%, respectively, when tested with sender V. Furthermore, sender V consistently surpasses senders B and D in performance on the p8l and px6a devices, highlighting a notable disparity in efficacy. Conversely, when evaluating the performance on the op7 and a53 de-vices, the results among senders B, D, and V demonstrate a remarkable uniformity, with only minimal variations in accuracy. The most significant discrepancy observed is a 6% difference between senders B and D when assessed with four classes on the op7 device. This suggests that while op7 and a53 provide more consistent and higher performance across different senders, p8l and px6a exhibit limitations, particularly in terms of ac-curacy and sender variability. Consequently, sender V not only shows higher accuracies across the board but also appears to be more resistant to accuracy drops as the number of classes increases. This suggests that V's data might be inherently more separable or that V employs more consistent patterns in location-related behavior. Overall, the presence of differences in performance between the senders within the same device and class configuration underscores the variability in sender effectiveness.

### Multiple Senders: Simple Combination

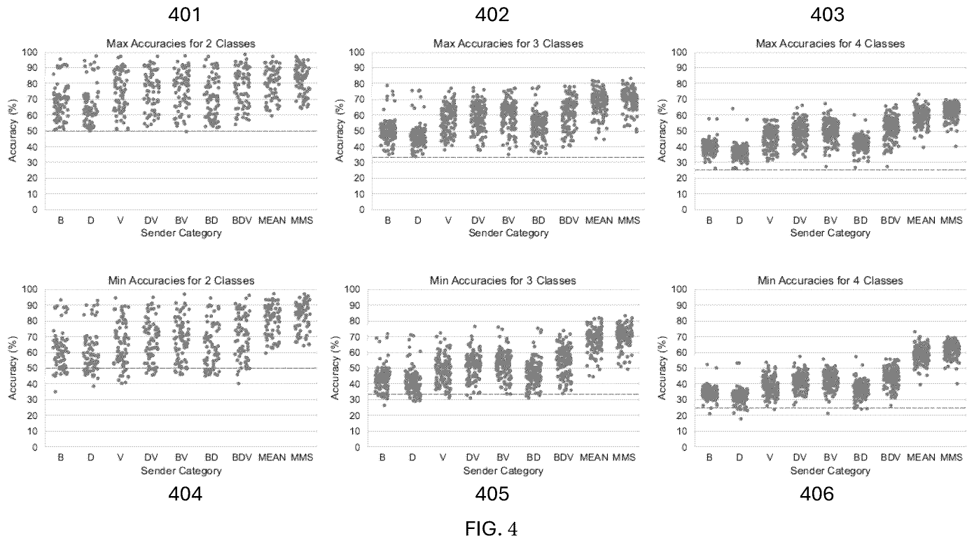

Double- and triple-sender accuracy scores are compared with the single-sender scores. In FIG. 4, all classification accuracy scores are shown with the worst (minimum) and best (maximum) performances of the single- and double-sender data, across all devices and sample sizes in graphs 401, 402, 403, 404, 405, and 406. The scatter plots illustrate the accuracy points between different sender types and classes. All devices and sample sizes are considered. The plots with the minimum accuracy scores take the worst performance of the single- and double-sender data, while the maximum accuracy scores focus on the best possible (in this setup). The aim is to show the minimum and maximum improvement of the multi-senders with simple combinations, based on this collected dataset.

Sender V consistently emerges as the top performer across all metrics, capturing both the lowest and highest scores. However, this trend does not uniformly extend to scenarios involving double- and triple-sender configurations. Initially, all multi-sender combinations yield superior accuracy rates compared to individual efforts by senders B and D, underscoring the premise that pooling sender data can enhance overall performance. Notably, in binary classification tasks, sender V is marginally eclipsed by combinations such as DV, BV, BD, and BDV, and similarly by DV, BV, and BDV in contexts involving three and four classes. On the contrary, the BD pairing underperforms for three and four classes, highlighting that sender D's contributions do not bolster the collective accuracy to the same extent as other senders in these specific instances. This phenomenon underscores a critical insight: a sender with generally lower performance can, in certain conditions, detrimentally impact the collective accuracy of multi-sender configurations.

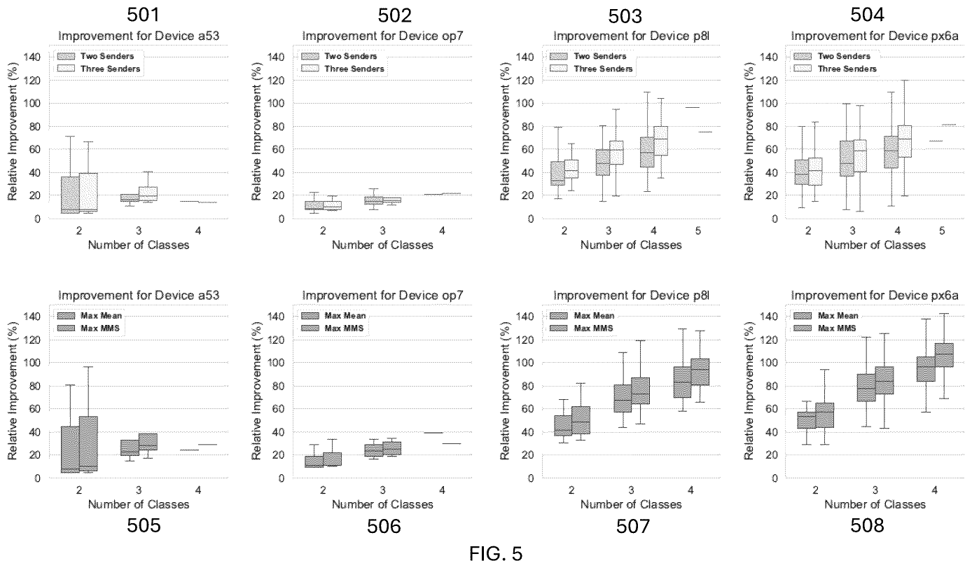

To illustrate the enhancements in accuracy achieved by integrating multi-sender data over single-sender benchmarks, FIG. 5 is included. FIG. 5 illustrates the best accuracy improvement of all multi-sender techniques from the single-sender baseline (not globally optimal), across all sample sizes in graphs 501, 502, 503, 504, 505, 506, 507, and 508. Lines in 4 and 5 classes indicate that there was only one classification, meaning one accuracy outcome. This figure highlights the maximal accuracy improvements realized for configurations involving two and three senders combined. It provides a detailed examination of the specific devices engaged in experiments and quantifies the average accuracy enhancement across different class numbers. For each classification category, the lowest accuracy scores are pinpointed from single-sender scenarios and juxtaposed with the highest-performing scores from multi-sender configurations across all sample sizes. This approach was designed to showcase the performance improvements achievable with multi-sender strategies within the dataset. The underlying principle is that the attacker can always adapt the classifications by choosing the best-performing multi-sender combination.

The analysis reveals that for devices a53 and op7, enhancements from multi-sender configurations are relatively modest for binary classifications. This is attributed to the already high performance of single-sender setups in these instances (as detailed in FIG. 3). However, the narrative shifts significantly for classifications involving three and four classes, where improvements of approximately 20% are observed. The scenario is even more pronounced for the p8l and px6a devices, which exhibit progressively larger gains in accuracy with an increase in the number of classes. Notably, the peak improvement recorded is an impressive 120% for the px6a device within four-class scenarios using three senders (namely, the BDV combination).

This data suggests a clear trend: Classifications that initially present lower accuracy in single-sender formats tend to benefit substantially from the incorporation of multi-senders, particularly in multi-class classifications.

### Multiple Senders: Statistical Combination

A comparative analysis is run between the performance of individual senders and the aggregated results from multiple senders, specifically focusing on the statistically enhanced Mean and MMS datasets. These datasets incorporate data from all three senders at their largest sample sizes, representing the best dataset advancements explored in this study.

By observing FIG. 4 once more, it becomes apparent that the Mean and MMS datasets exhibit superior performance for binary classifications compared to other methodologies. This is particularly noticeable in their minimum accuracy scores, which significantly exceed those achieved by alternative approaches. The gap between the Mean and MMS datasets is relatively narrow, with the MMS dataset showing a marginal enhancement in accuracy. However, the distinction in performance between these advanced datasets and other techniques becomes starkly apparent in the analyses for three and four classes. For these more complex classifications, the MMS dataset demonstrates a better performance than the Mean dataset, unlike the improvement observed in bi-nary classifications. The results indicate that the MMS is currently the best-performing method for location identification, especially for multi-class classifications.

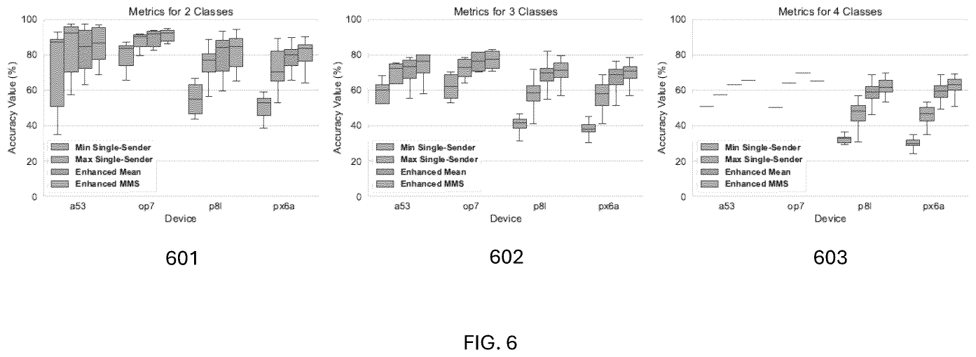

To further investigate the improvement of the Mean and MMS datasets per device, the corresponding boxplots of FIG. 5 are examined, which illustrate the improvement percentages for the enhanced datasets for the four distinct devices. These plots reveal the percentage improvements of the advanced datasets across four distinct devices. For devices a53 and op7, the increments be-tween the Mean and MMS methods are relatively modest. However, as the focus is shifted to devices p8l and px6a, especially with an increasing number of classes, the distinction becomes more significant. The MMS dataset showcases the maximum improvement, reaching up to 142% for a four-class scenario on the px6a de vice. Furthermore, when juxtaposing the performance of the Mean and MMS datasets against results from two or three senders, the superiority of the MMS strategy becomes more evident. Particularly, the MMS dataset demonstrates considerable superiority over the conventional multi-sender combinations, highlighting its effectiveness not just in enhancing accuracy, but also in providing a more consistent and reliable performance across varying class complexities and devices. This comparative analysis not only underscores the value of the MMS approach but also positions it as a notably advanced methodology within the scope of the investigation, significantly outpacing traditional techniques in terms of performance improvement. Still, FIG. 5 displays the best improvements, but they are not considered as global optimal, since there might be ways to enhance these techniques even further. Finally, FIG. 6 provides additional information comparing the Mean and MMS results to all single senders with all sample sizes.

FIG. 6 illustrates accuracy boxplots 601, 602, and 603 between the single-senders and the enhanced multi-sender approaches for all classifications. The plots consider the worst and best performing accuracy scores for single senders. These distributions show that MMS achieves the best improvement (not global optimal).

### Sample Size Comparisons

In machine learning, the sample size is a significant factor that influences the model's performance. A sufficient sample size ensures that the model can capture the diversity of the entire population within the data. Typically, larger sample sizes provide more data points for the mode to learn from, which can lead to higher accuracy and reliability. To determine whether the accuracy increases as the sample size increases, the performance metrics of single-, double-, and triple-sender results are analyzed across a sample size range from 100 to 1000.

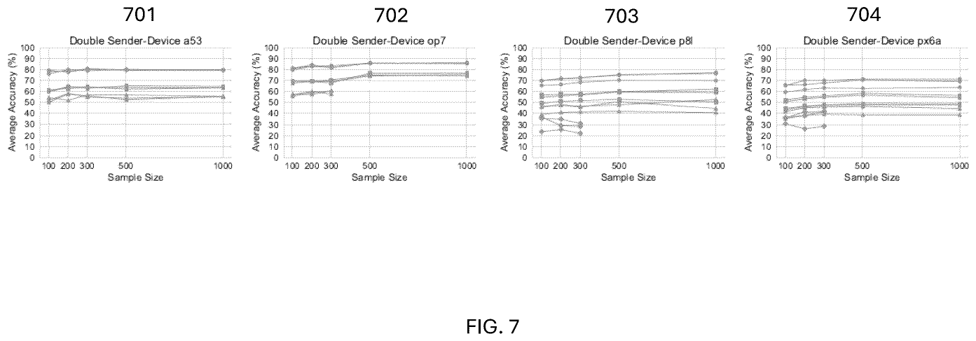

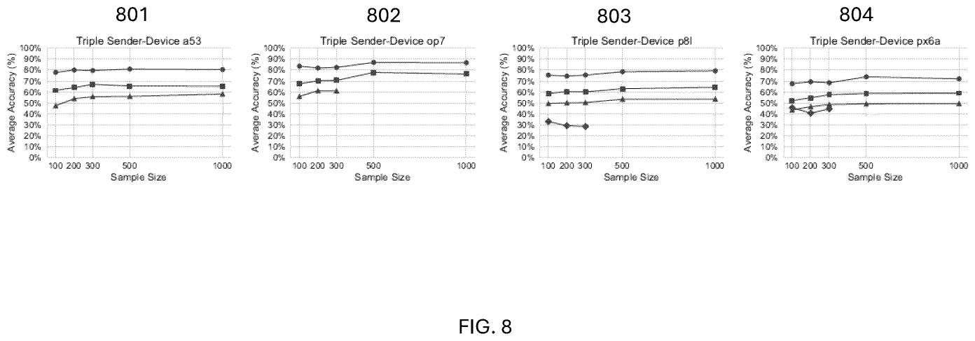

For single-senders B, D, and V, FIG. 7 shows the average accuracy for all number of classes in each device, unveiling a trend where accuracy generally stabilizes with an increase in sample size across various device contexts. FIG. 7 illustrates single-sender accuracy trend plots for each device, per number of classes in plots 701, 702, 703, and 704. The trends behave steadily and continuously in most cases, as the sample sizes expand. B, D, and V are included for 2 (∘), 3 (□), 4 (Δ), and 5 (⋄) classes. For double-senders BD, DV, and BV, FIG. 8 reveals a consistent pattern of steady or small improved accuracy with larger sample sizes, across all class numbers. FIG. 8 illustrates accuracy trend plots per number of classes for two and three senders in plots 801, 802, 803, 804, 805, 806, 807, and 808. The trend is rather steady and continuous as the sample sizes expand. BD, BV, DV, & BDV are included for 2 (∘), 3 (□), 4 (Δ), and 5 (⋄) classes. The pattern from FIG. 7 persists into FIG. 8, representing triple-sender configurations, where the trends once again affirm the model's steady performance with increased data volume for each class number per device.

Regarding the classification, the trends give the in-sight that the model may be well-tuned to the complexity of the task at hand, effectively capturing the patterns within the available data. In addition, this means that the key features and patterns necessary for making accurate predictions are already captured within the smaller dataset. Steadiness after a certain sample size also shows that the model's structure is robust enough to perform reliably under varying dataset conditions.

Consequently, for the attacker, these are promising results as it is not necessary to collect large amounts of data, corresponding to the SMS transmissions, in order to conduct the location identification attack. This can be beneficial in reducing the measurement collection time, computational costs, and training time, making the model more efficient to develop and deploy, where acquiring large volumes of data is challenging or impractical. Additionally, this can also make the adversary less susceptible to detection, since the attacker can adapt to the least amount of SMS transmission and senders for the desired accuracy.

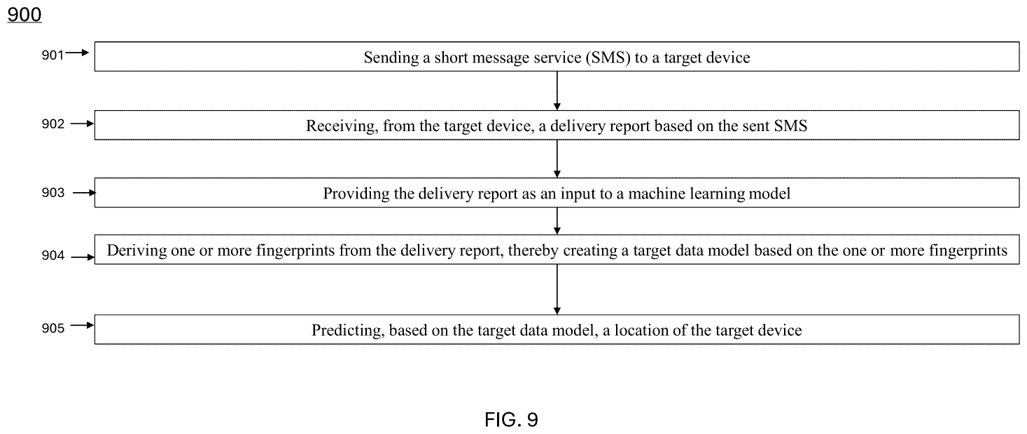

FIG. 9 is a process diagram 900 for a method of determining a location of a target device. In step 901, the method may include sending a SMS to a target device via a SMSC. In some embodiments, the target device location is stationary. In some embodiments, the target device location is dynamic. In step 902, the method may include receiving, from the target device, a delivery report based on the sent SMS. In some embodiments, the delivery report is triggered by receipt of the SMS at the target device. In some embodiments, the delivery report comprises one or more delays from the target device. In some embodiments, the one or more delays comprise a processing delay, a routing delay, and/or a propagation delay. In step 903, the method may include providing the delivery report as an input to a pretrained machine learning model. In some embodiments, the pretrained machine learning model is an artificial neural network. In some embodiments, the artificial neural network is a multilayer perceptron classifier. In some embodiments, the pretrained machine learning model is trained on a dataset of fingerprints of known locations of target devices. In step 904, the method may include deriving one or more fingerprints from the delivery report, thereby creating a target data model based on the one or more fingerprints. In some embodiments, the one or more fingerprints comprise a time delay based on the target device location. In step 905, the method may include predicting, based on the target data model, a location of the target device.

In some embodiments, the method 900 further comprises sending a plurality of SMSs to the target device from a plurality of locations.

The strategic placement of sender locations, adhering to the principle of distancing them by several kilometers, aims to capture diverse timing characteristics (e.g., via different routing), since the networks are black-box to the attacker based on threat model. The most suitable locations are utilized, for which a sufficient amount of data is continuously collected and for a long time. Expanding the number of senders and diversifying locations internationally as well can potentially improve the accuracy of attack even further.

Ways to mitigate this attack can span from the elimination of silent SMSs and delivery reports to the implementation of more rigorous SMS filtering mechanisms for spam and flooding, which represents one of the most direct and practical countermeasures against location identification attacks. Enhancing the core concept of resilient spamming/flooding filters, networks are encouraged to integrate advanced anomaly detection systems in order to accurately distinguish between normal and anomalous patterns of SMS traffic. However, it's important to acknowledge that these systems primarily operate based on predefined rules and thresholds for anomaly detection, thereby limiting their efficacy to merely delaying, rather than outright preventing, the execution of such attacks.

To further complicate the attacker's efforts in utilizing timing information, the implementation of adaptive jitter mechanisms introduces a more nuanced counterstrategy. These mechanisms, capable of introducing variable delays in SMS processing, adjust dynamically in response to fluctuating network conditions and traffic patterns. This adaptability ensures that networks can impede side-channel analysis through effective timing obfuscation. Nevertheless, considering the sophisticated strategy of attackers deploying multiple senders across different geographical locations and leveraging various networks, the effectiveness of previously mentioned countermeasures could be compromised. To address this, networks could adopt a multi-layered defense strategy that also considers the following methods:
Geographic Analysis of Source: Implement anomaly detection systems that not only monitor the frequency and pattern of messages but also analyze the geographic origins of SMS traffic. By identifying unusual patterns of messages coming from multiple locations (also through roaming) targeting a single number, the system can flag potential coordinated attacks.
Adaptive Routing: Dynamically alter the routing of messages based on real-time analysis to disrupt the timing measurements of attackers. This could involve randomizing the path messages take through the network or introducing variable delays for messages from identified suspicious sources and roaming.
Joint Defense Initiatives: Since the attacks can happen internationally from any location, it is imperative to establish shared intelligence on known attack patterns, including the use of multiple senders, across networks. Networks that work together can implement joint defense measures, such as coordinated blocking of attack sources and unified response strategies to emerging threats.

This technology offers significant performance advantages over current methods of user localization. Its core strength lies in its use of Machine Learning techniques in combination with timing-based analysis of SMS delivery reports, unlike GPS or Wi-Fi signals. The system may achieve impressive localization results, accurately determining the recipient's multiple locations, even across different countries and operators.

The technology's global scalability is a major performance advantage. Its ability to work across various countries, operators, and devices makes it universally applicable. This scalability facilitates widespread adoption and seamless application, regardless of the geographic region or cellular network provider, making it highly versatile and accessible to diverse user bases. Another key performance advantage is the real-time and seamless tracking it offers. While many traditional methods may require user consent or active participation, this technology operates as a passive observer of SMS communication. This enables real-time and discreet tracking without the need for user cooperation. As a result, the sender can quickly and seamlessly probe the user's location at any time, providing immediate results for time-sensitive applications. In addition, efficiency and low latency are other prominent benefits of this technology. By relying on SMS communication and avoiding the need for real-time internet connectivity or complex data processing, the system ensures efficient handling of localization requests.

Additionally, the technology's simplified implementation process contributes to its performance superiority. With minimal equipment requirements, such as a computer and an Android device running coding scripts, businesses and organizations can integrate it seamlessly into their existing systems. This straightforward integration reduces implementation complexities and lowers the barrier to adoption, ensuring faster and more efficient deployment. Lastly, the technology's resilience to internet connectivity issues further enhances its performance advantage. As it operates independently of real-time internet access, it remains functional even in areas with limited or no internet connectivity. This resilience ensures continuous user localization capabilities, making it invaluable in remote or underserved regions and during emergency situations. In conclusion, this technology excels in various aspects, providing a compelling set of performance advantages. From its high accuracy and real-time tracking capabilities to its global scalability, this innovative solution surpasses the limitations of some existing methods, presenting itself as a powerful and efficient tool for user localization in cellular environments.

### Background on SMS Networks

### Cellular Network Architectures

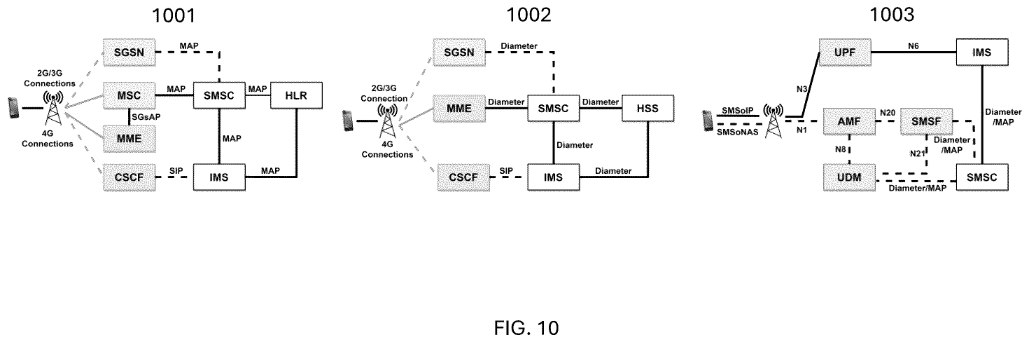

FIG. 10 shows an extended version of 4G/LTE (schematics 1001 and 1002) and 5G standalone (schematic 1003) architectures for the SMS procedure including the 2G/3G structures.

5G has two SMS delivery routing paths and protocols: SMSoIP and SMSoNAS. SMSoIP or IP-based communication (data-plane) leverages the SIP protocol and the IP Multimedia Subsystem (IMS) architecture to communicate with the SMSC. SMSoNAS uses the Non-Access Stratum (NAS) protocol for SMS transmission and delivery, providing NAS encryption and integrity-protection through control-plane traffic after establishing the security context.

Furthermore, LTE services support chiefly IP-based communication through the IMS (FIG. 10), then alternatively the SGsAP interface, which eliminates the need for 2G/3G fallback, and finally, the NAS signaling communication combined with the Diameter protocol. Typically, the IMS incorporates the IP Short Message Gateway (IP-SM-GW), an IMS Application Server that handles SIP-based messaging services for IMS subscribers.

The selection between SMSoNAS and SMSoIP depends on the SMS originator and the network support, even though IP-based communications are more prevalent, as the User Equipment (UE) subscribes to the IMS after completing the Authentication and Key Agreement (AKA) procedure with the Core Network.

### SMS Procedure

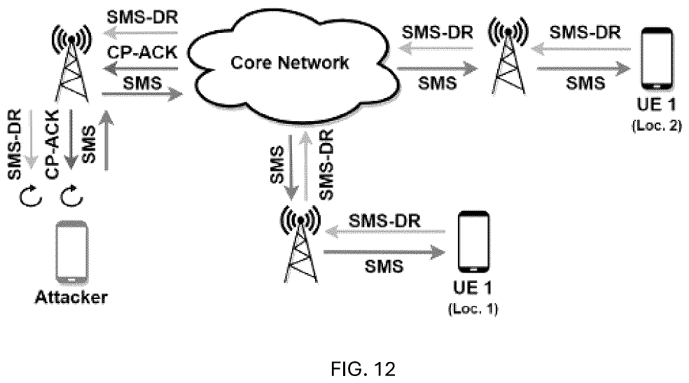

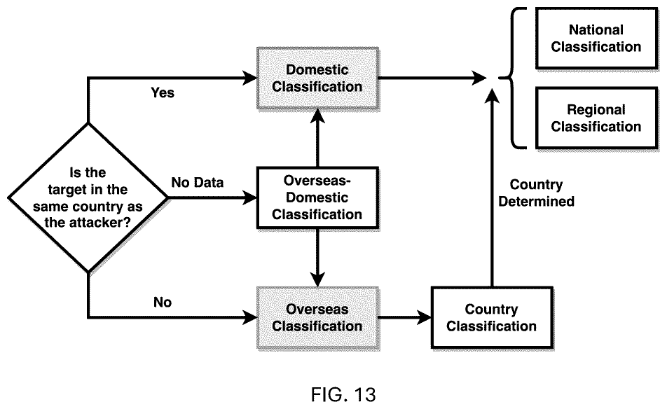

SMS services are accessible to all network generations (2G-5G) as a process of exchanging short text messages between two network subscribers. The SMS exchange between originator and recipient requires forwarding to the Core Network, where the SMSC manages the SMS process and delivery (FIGS. 12 and 13). After receiving the message, the recipient sends a Delivery Report, which is forwarded through the SMSC to the originator acknowledging the delivery. Delivery Reports provide detailed information on the status of every message sent including “Delivered,” “Accepted,” “Failed,” “Undeliverable,” “Expired,” and “Rejected.” Failed deliveries could be due to incorrect phone number, dis-abled international roaming, unreachable recipient, mobile plan restrictions, etc. Note that delivery notification is enabled by the originator in their phone's settings on modern smartphones. Delivery Reports are used for data cleansing/updating, improving response rates, audit trail, and systems monitoring.

There are three primary SMS statuses: i) Sent, which indicates that the mobile device has sent the SMS to the SMSC and the SMSC has confirmed its reception, ii) Delivered, meaning that the recipient has received the SMS and has responded with the Delivery Report, and iii) Failed when errors occur.

### Network Delay Factors

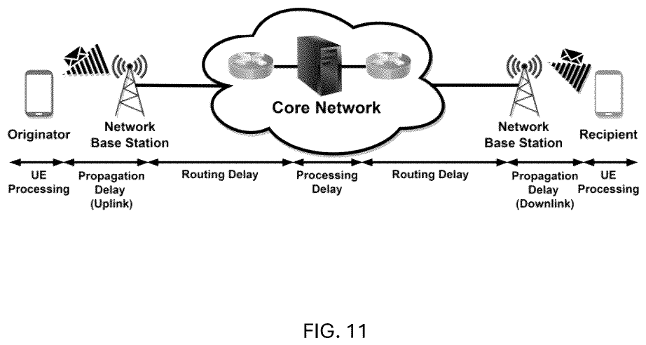

FIG. 11 illustrates various delays for an SMS transmission between two users. Similar delays apply for the Delivery Report which is sent back to the originator.

SMS text transmissions and Delivery Reports incur timing delays in the communication channel. FIG. 11 illustrates the delays for a single SMS transmission between the originator and the recipient.
(1) UE Processing: This is the time taken by the phone to process the SMS for transmission or reception. The corresponding base station has already completed its transmission at that time. The processing includes the modem and OS procedures, and the user-related services used (e. g., calls, SMSes, mobile data) that occupy uplink and downlink resources.
(2) Propagation Delay: This depends on the RAN net-work's design, configuration, and deployment including the front-haul of the mobile network, physical properties and quality of the signal, transmission capabilities of the base station, and management of the uplink and down-link communications.
(3) Routing Delay: SMS messages pass through multiple network entities depending on the architecture and the generation (e. g., LTE, 5G, etc.). Routing delays occur in the mobile back-haul, i. e. the transport network that connects the core network and the RAN, as well as within the core network. Apart from the SMSC and the gateways, the SMS may require additional processing, e. g., by the AMF (5G SA), MME (LTE-5G NSA), and IMS, before reaching the destination, thereby also contributing to the routing delays.
(4) Processing Delay: This delay generally includes the SMSC, the IMS, and MSC/MME/AMF processing. The SMSC manages the SMS reception and delivery process and may also deploy congestion, filtering, and prioritization techniques.

### SMS-Based Location Inference Attacks

### Attacker Goal and Assumptions

The attacker's goal is to locate the victim receiver's whereabouts, specifically, whether the victim's mobile is in a specific geographic area of interest.

It is assumed that the attacker knows the victim's mobile number and can send an SMS to that number. The SMS can be regular private messages, undirected mass messages (e.g., marketing, advertisements) that the victim will likely ignore, or a silent SMS that victim's device acknowledges without any content or alerts, remaining entirely unnoticed by the victim. It is assumed that the attacker can target any subscriber (victim) with a valid mobile number attached to a cellular provider and maintain a typical connection to send text messages to the victim and receive delivery notifications. The adversary can access any network operator using the corresponding (e) SIM as a normal user.

Additionally, it is assumed the attacker can collect measurements from locations of interest directly from the victim when located at specific locations/areas of interest (without revealing the attack) or deploy similar devices and connections as the victim at these locations for data collection. The attacker is not limited in terms of the number of smartphone devices, (e) SIMs, mobile numbers, or subscription plans. The attack does not require physical access to the victim's USIM cards, mobile de-vices, or any network entities (e. g., base stations, core network, etc.). Finally, the attacker neither obtains nor modifies sensitive information, e. g., cryptographic keys.

### Timing Features

As shown in FIG. 12, SMS transmissions to different de-vice locations generate acknowledgments from the core network (CP-ACK) associated with Sent notification and Delivery Reports (SMS-DR) from the receivers resulting in the Delivered status.

The attack is conducted in two phases: (i) Preparation and (ii) Attack.

In the Preparation phase, the adversary repeatedly sends multiple (silent) SMS, with Delivery Reports enabled, to the victim while observing their respective locations. The attacker collects measurements to identify the timing characteristics of the victim's locations. Despite being aware of the victim's locations at this stage, the victim will not notice that they are being surveilled when the adversary uses silent SMSs. Using these measurements and analyzing the different timing features, fingerprints for each of the victim's locations are generated.

In the Attack phase, the adversary collects new measurements without knowing the victim's location and at-tempts to determine their current location based on the timings. To do this, the adversary must solve a classification problem, i.e., assign the newly observed measurements to one of the previously seen locations by comparing timings with the respective location fingerprints. De-pending on the victim's movement patterns and the locations observed in the preparation phase, the classification occurs in multiple iterations. Therefore, the classification problem is partitioned into a step-wise location prediction problem involving several location identification tasks with decreasing granularity levels from classifying international locations to regional (e. g., at city-level).

### Classification Methodology.

The classification approach that the attacker follows to retrieve a victim's location is described in multiple iterations (FIG. 13). An example is shown of a victim moving internationally.

Initially, the attacker may not have sufficient intelligence regarding the victim's current country of residence. Thus, the first step is to determine whether the victim is Overseas or Domestic. If the victim is overseas, then the attacker proceeds with determining the specific country (country-based classification). Once the country is known, the attacker may choose to perform either a national or regional classification depending on the at-tacker's objectives and the victim's routine. In the regional classification, the attacker attempts to discover the victim's location within a limited area, while the national classification has a macroscopic view of the country, incorporating cities and towns.

Having knowledge about the victim's general geographical whereabouts such as North America, can help narrow down potential candidate locations making classification more manageable. If there is only one country and one city, the methodology can be simplified to just regional location identification. Therefore, the attacker does not need to adhere to the entire methodology as it primarily depends on the victim's routine.

### Validation

SMSs are sent between smartphones at different geographical locations to collect measurements for experiments. The setup includes active devices (phones) controlled via the Android Debug Bridge (ADB) to send SMSs to other devices. These phones are configured to analyze cellular traffic and baseband logs to extract timing and network information such as protocols, connections with the core network, AT SIM commands, etc. Active devices have SMS Delivery Reports enabled to visualize notifications while sending messages. Passive devices are used to receive messages.

Devices are located across several countries, including the United States (US), UAE (AE), and seven countries in Europe (BE, DE, DK, GR, LU, NL, UK). The experiments cover ten operators and several generation technologies such as LTE, LTE+, 5G NSA/SA. Additionally, the approximate channel condition such as strength and quality are recorded for each receiving location. Table 3 presents the relevant characteristics of all locations that appear in the measurements.

Three rounds of measurements serving different purposes are conducted:
(i) Long-distance international measurements with devices in multiple countries, with the sender located in AE-1.
(ii) Messages are sent from a single active device to passive devices at various domestic locations, including multiple cities and locations within them, for AE, GR, DE, NL, BE, and LU. The experiments are conducted from different sender locations, with the sender in AE-1 for AE experiments, GR-1 for the GR experiments, and DE-4 for the rest. The primary objective is to demonstrate a practical and realistic scenario involving a person's natural everyday behavior on a smaller scale including regular commuting to adjacent countries.
(iii) Measurements are collected across different operators and roaming devices at several locations. Specifically, a focus is on on distinguishing between network operators and smartphone devices which assists location identification.

### Measurement Collection

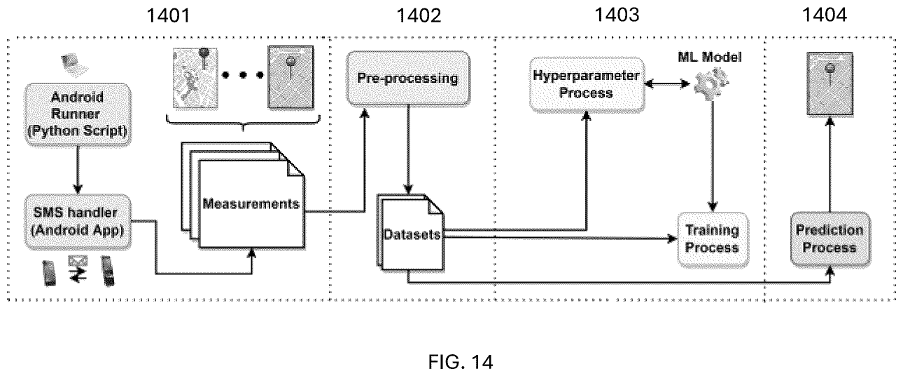

Data collection is sketched in step 1401 of FIG. 14. An Android application, SMS handler, runs on active devices and sends one silent SMS at a time to a target device. Once the SMS is sent, the application waits for the Delivery Report (both Sent and Delivered notifications) and records all the required timestamps and computes the features.

A python script, Android Runner, is used to automate SMS transmission to a designated receiver and capture the Delivery Report timings for each SMS. The script interacts with the smartphone through basic ADB commands and key events (to press buttons, fill text input fields, etc.) without requiring device rooting. The script runs on a Dell Latitude E5450 and a regular desktop computer using a cronjob for re-peated execution.

An SMS burst, i.e., consecutive 20 SMS transmissions, is scheduled on an hourly basis. To distribute the SMSs for each location, the SMSs are spanned over 2 to 3 days to avoid potential SMS spam filtering and prevent network congestion, which may affect the timings. This procedure also helps collect representative traffic dataset, including various times of the day, potential network configuration changes, and different levels of network loads.

Whether the active device sent the silent SMS successfully is constantly monitored. The Android logging tool Logcat may be used to investigate the routing methods and connection establishments and track the SMS procedures.

### Dataset Generation

In step 1402 of FIG. 14, the timing features from the collected data are calculated, location signatures are generated, each composed of all six timing features obtained during or derived from a single measurement iteration.

The evaluation dataset contains signatures for each candidate location, covering various granularity levels, from domestics and overseas to national and regional classifications. In the data, the SMS routing modes are also identified, i. e., SMSoIP for LTE/LTE+, SMSoIP for 5G, and SGsAP/Diameter for LTE/LTE+.

### Location Classification

In steps 1403 and 1404 of FIG. 14, the process used Multilayer Perceptron (MLP) with Python's SKLearn libraries as classifier to per-form location classification because of its flexibility in parametrization and high performance on large datasets. The model comprises a stochastic gradient descent solver, softmax and sigmoid activations for multiclass and binary classifications respectively, and three layers with 10, 40, and 10 nodes respectively for the input, hid-den, and output layers. Additionally, the maximum iterations were set to 5000, the learning rate to be constant, batch size to be 32, and the alpha to 0.0001. Automatic and manual parameter tuning were performed to improve the model's accuracy. Accuracy is a focus throughout classifications, measuring the number of correct predictions out of the total predictions made.

The training and prediction procedures correspond to steps 1403 and 1404 in FIG. 14. The datasets are randomly split, while the class with the highest probability is assigned by the MLP classifier as the prediction result. Training and prediction processes utilize the cross-validation methodology with 10 k-folds to prevent over-fitting and promote model generalization. The performance of a Random Forest Classifier, Decision Tree Classifier, and Recurrent Neural Network with Keras libraries were also compared, but the optimized MLP outperformed them all.

### International Classification

For the international classification, large geographical areas of the victim are focused on, primarily attempting to identify locations in different countries.

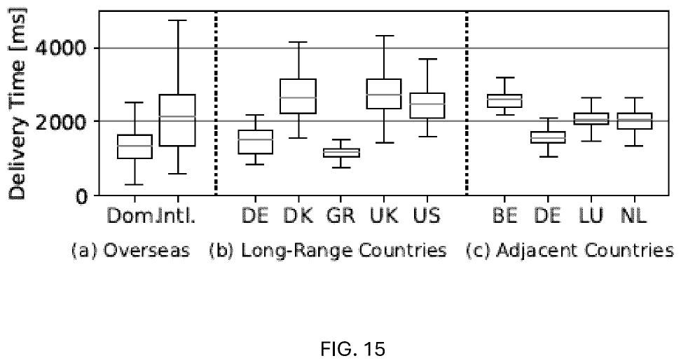

Overseas-vs.-Domestic Classification aims to determine whether the victim is within the home country or abroad. This binary classification experiment groups the AE locations (home country) together and Int-X locations together. The results indicate that the target can be identified with an accuracy of 96%. The two box plots in FIG. 15 show a clear timing difference between the two classes based on the Delivery Report (T_{del}), facilitating accurate identification.

Country-based Classifications aim to determine the victim's location in a specific country. First, experiments are conducted in countries that are far apart to demonstrate the existence of timing differences. Multi-class classification is performed for all Int-X locations in different countries and achieve 96% accuracy. The box plots in FIG. 15 depict the timing difference in the dataset between GR, DE, DK, UK, and US locations. Next, only EU countries are or a multi-class classification to identify locations within a smaller geographical area. Int-GR, Int-DE, Int-DK locations (sender AE-1, based on another continent) are used, achieving 95% accuracy.

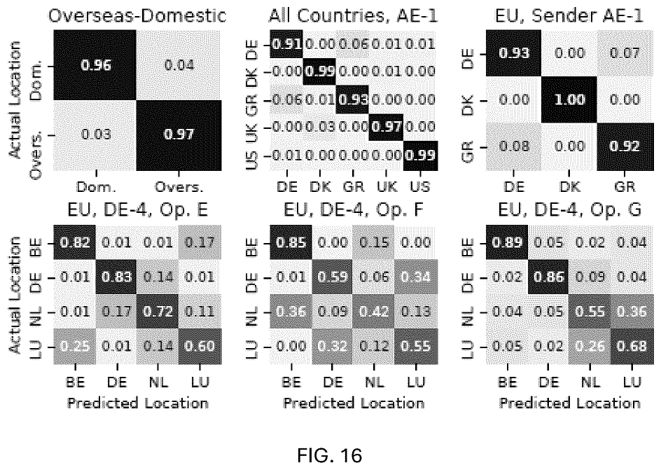

In FIG. 16, the confusion matrices are presented for the overseas-vs.-domestic and country-based classifications. The figure confirms the high-accuracy results from the table and identifies the predictions that lead to less accurate results, involving classification with sender DE-4 and nearby receiver countries. For operators G and E, LU and NL receiver locations result in higher misclassifications than for DE and BE. The model also shows a loss of accuracy for operator F, where timing characteristics for DE, LU, and NL cause errors due to similarities, but the most likely returned result is still the correct one for each case.

Finally, a country-based classification targeting adjacent and nearby countries was performed to identify even closer geographical locations. The victim traveled to DE-4, NL-4, BE-1, and LU-1 using operators G, E, and F. The classifiers achieved 75%, 74%, and 62% accuracy for these specific locations using operators G, E, and F, respectively. These three EU country-based classifications with four classes have an average accuracy of 70% with the best performing being 75% for operator G and E. FIG. 15 shows the timing difference between those countries with NL-4 and LU-1 having similar delivery timings. However, raw delivery timing is only one of the six features taken into consideration in this case.

### National and Regional Classification

Fixed Locations. The classification achieves an average performance of 68% in Germany based on 57 classifications of pairs of two locations. However, performance varies depending on the pairs of locations, so the aver-age must be interpreted carefully. The best performing classification (DE-3 and DE-5) achieves 92% classification accuracy. Detailed results for all pairs of locations in Germany are presented by the matrix in Table 9. The average performance for the Netherlands across 15 classifications of location pairs is 63%, with 98% classification accuracy for NL-2 and NL-3. For Belgium, the overall performance is 86%, but this only includes four classifications of the same two locations (BE-1 and BE-2) 40 km apart from each other, using different phones.

The classification scores decrease for larger sets of locations in all countries, but it should be noted that the chance of randomly guessing the correct location is also lower (e. g., 33% for 3 locations instead of 50% for 2 locations). Nevertheless, the average classification scores of 76% and 79% in the UAE and in Greece, respectively, still indicate a high performance.

Areas with Multiple Locations. Areas can be challenging to distinguish as they are not associated with the at-tributes of one location only and may overlap. Area classification results for DE locations are reported in Table 9, and for international experiments in Table XX. In binary classifications, the model achieves an average accuracy of 57% for 21 classifications, with DE-6 and DE-8 being the best-performing pair reaching 72%. For three and four classes in DE, the model achieves 41% and 34%, respectively. Similar to the fixed locations, performances should be read and understood separately, as each combination has different features.

Mixed Locations. In this scenario, the combinations of fixed locations and areas shows that the attacker is not limited to distinct types only. Measurements from DE, NL, BE, and LU are used for the classification tasks in Table 3. In binary classifications, the model achieves 67%, 71%, 77% and 67% on average for DE, NL, BE and LU locations, respectively, while reaching up to 88% in certain classifications. The model scores lower for classifications that include three, four, and five locations. For example, DE has an average ac-curacy of 50%, 41%, and 34% for three, four, and five classes, respectively. Nonetheless, the large number of classifications with even diverse features should be taken into account cautiously, i.e., 252, 402, and 398 for three, four, and five classes, respectively.

The performances of classifications are highly variant depending on the sets of locations. FIG. 16 illustrates the distribution of the performance of all classifications. Detailed results for individual classifications for all pairs of locations for each country are in Tables 6-8.

### Misclassification Errors

In location identification, a misclassification error for an SMS measurement means that the timing pattern is matched to the wrong location, i.e., wrong pattern distribution. False results can arise due to various machine-learning (ML) factors, such as overfitting and model complexity, as well as in the form of outliers due to special network conditions. In any case, more sophisticated and motivated adversaries with more resources and ML expertise may enhance the model to improve the attack.

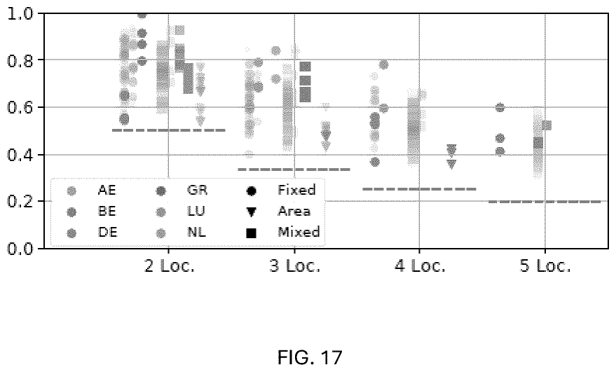

Country-based classifications are primarily impacted by factors such as adjacency between countries and net-work homogeneity (including similar operators), making it more challenging to distinguish locations. The impact of these factors can be seen for operators E and F in FIG. 17 for LU and NL. In fixed locations, timing similarities between locations (with the same UE and operator) can make the classification less precise due to congruent variance in network delays. It can be even more challenging when locations are very close and have similar signal conditions, such as NL-1 and NL-2 for operator G (Table 8) with 62% accuracy. However, this is not always the case, as in the classification of DE-3 and DE-4 for operator E (Table 9) which achieves 87% accuracy. In addition, areas and mixed classifications can be similarly difficult to distinguish, as they combine measurements from multiple distinct locations and may over-lap. Nonetheless, Tables 8 and 9 include high accuracy scores even in such cases.

### Temporal Stability

A temporal stability analysis was performed to determine if the attack can still work even after some time has elapsed since the model was trained. For this purpose, the original attack evaluation was modified by training the model on a baseline dataset and testing it on measurements collected X days after the training phase. Therefore, new and protracted data are collected for the same locations with similar operators and devices to accommodate experimentation for up to one month and after three months from the initial training.

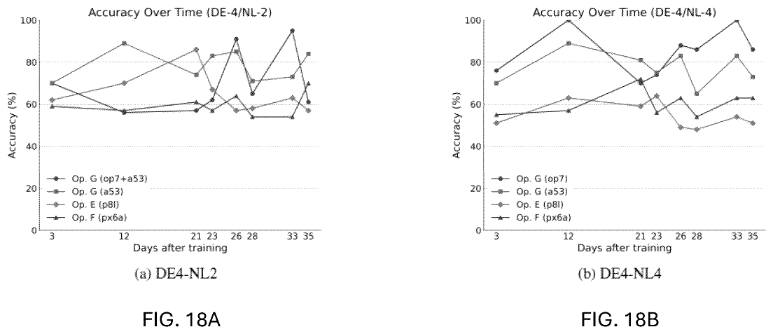

FIGS. 18A-18B depict eight examples of how the accuracy fluctuates for DE-4/NL-4 and DE-4/NL-2 classifications in a span of 35 days. Operators G, E, and F are used with Huawei P8 Lite (p8l), Google Pixel 6a (px6a), Samsung Galaxy A53 (a53), and OnePlus 7 Pro (op7) devices. Each trend represents specific device(s) and operator. According to the graphs, each combination has a distinct trend, as their measurements' characteristics differ. Consequently, increases and decreases in accuracy between various days are also expected for classifications in which the model scores both with high and low accuracies. Furthermore, in FIGS. 18A-18B, operator E with the p8l device is more susceptible to degradation than the rest of the combinations, but it takes more than 23 days for the degradation to slowly appear. Operator G with p8l in the DE-4/NL-4 classification shows a small degradation but retains high accuracy after 35 days. As a result, the collection of new data and retraining may not be necessary for all classifications. For classifications that continue to have high scores, the attacker may continue using their data.

### Network Analysis

The impact of congestion, potential network changes, and other time-varying characteristics are evaluated by running the location classification separately for different days and times of the week. The classification process is the same as the regular attack but with specific test data slices for different times of the day and days of the week. Measurements are grouped into four sets for different times of the day (0-5, 6-11, 12-17, and 18-23) and seven sets for days of the week. Data collected at two locations (DE-4 and NL-4) with sufficient measurements are used in the dataset for separate analyses across time slices, multiple phones, and operators.

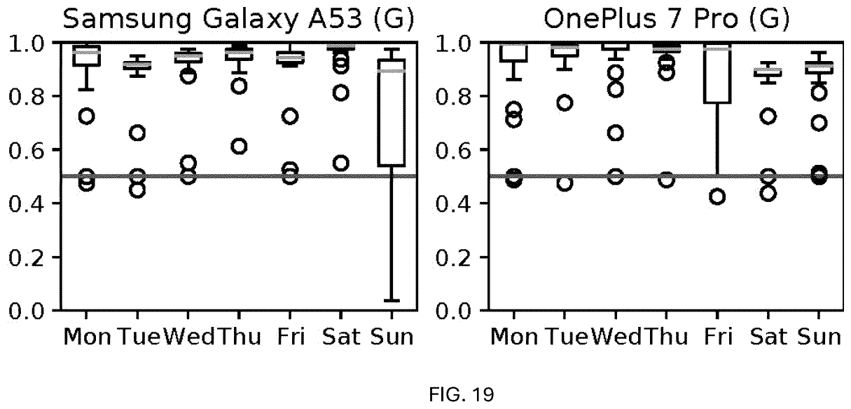

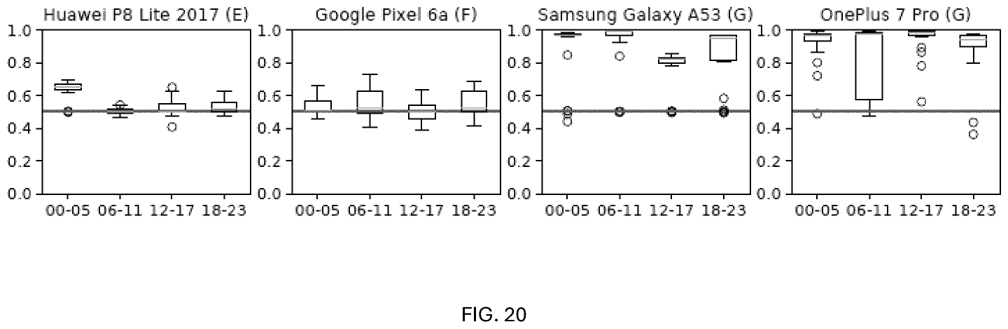

FIG. 19 shows the classification accuracy for two victim phones with one operator (G) throughout the entire week. The scores remained consistently high, with scores of 88% and 89% for OnePlus and Samsung, respectively. FIG. 20 also shows the model's performance for different time windows using four phones with three different operators. While performance differs across operators, with classification only working for G achieving around 80% and above, the scores generally remain stable throughout the day. The experiments illustrate results for specific locations, devices, and operators, and hence do not allow to draw general conclusions regarding the localization accuracy of specific devices. For the purpose of completeness, less accurate results are also included.

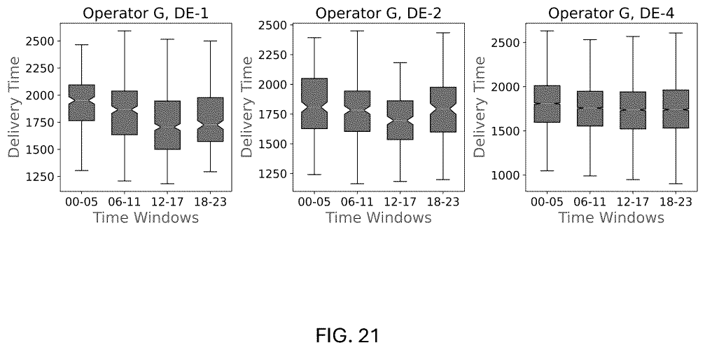

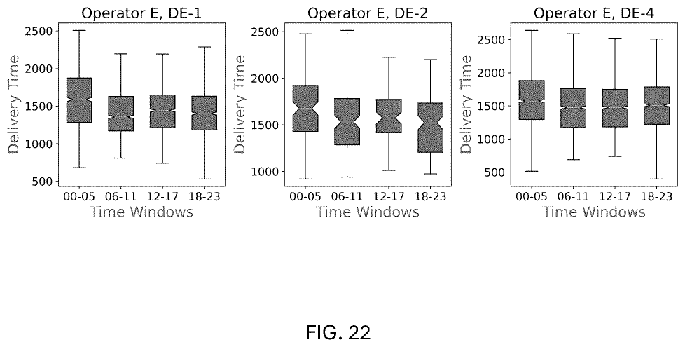

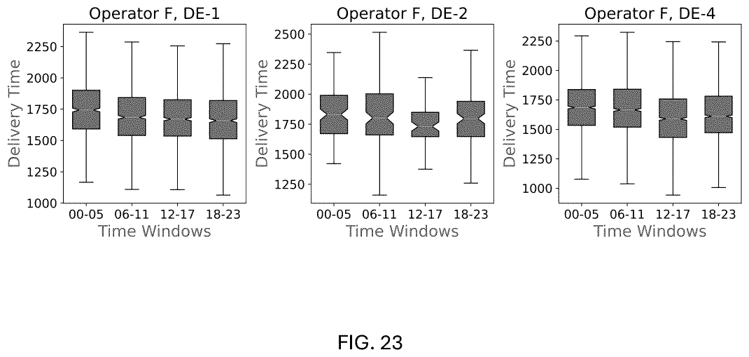

The delay across different operators and locations is further evaluated. FIGS. 21-23 show the distribution of timing delays for DE-1, DE-2, and DE-4 and operators E, F, and G, aggregated from all available phones from FIG. 20. No significant deviations in distributions throughout the day are observed for those locations and conclude that network characteristics are unlikely to substantially affect the model's performance.

### Distance Between Locations

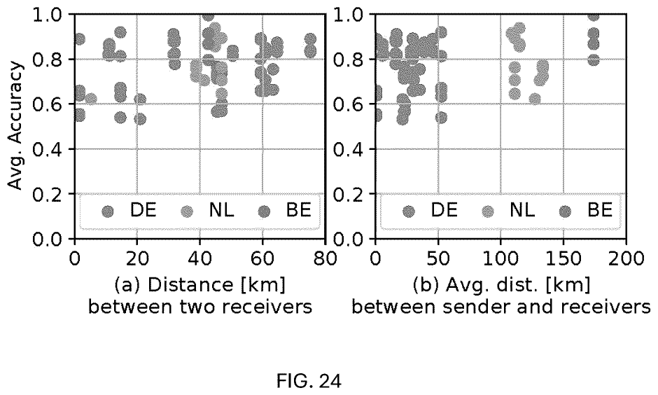

FIG. 24 shows the average classification accuracy for all pairs of locations in these three countries. It reflects the impact on accuracy of (a) the geographical distance between the two receiver locations, and (b) the distances between the sender and each of the receiver locations. For the latter, the average of the two distances is considered.

No correlation was found between distances and accuracies, contradicting the assumption that receiver locations further apart from each other or from the sender would result in more accurate classification. Therefore, distance may not be the main factor affecting classification accuracy.

### Open-World Scenarios

Open-world cases refer to unknown/unseen locations, for which the attacker has not accumulated measurements for model training. Three methods to tackle these cases that can be used separately or in combination are discussed.

First, the attacker can utilize outlier/anomaly detection mechanisms and unsupervised one-class classifications to reduce the “nearest neighbor” effect and identify if the data belong to an unknown location. An experiment was carried out using an Isolation Forest model. The model was configured with 100 estimators (without parameter tuning) and was trained on the domestic (AE) dataset attempting to identify overseas measurements during the prediction phase. With each class having 1200 samples, it achieved an 88% accuracy for anomaly detection indicating that the predicted data belong to an unseen location.

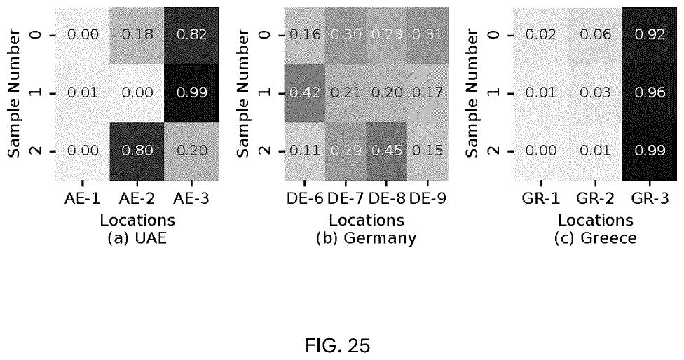

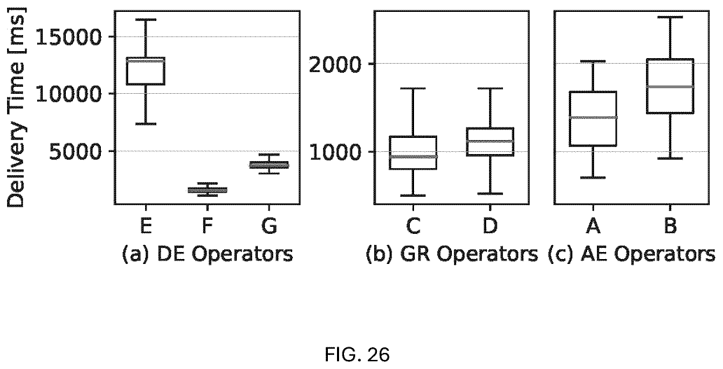

Second, the attack can be enhanced by modifying the MLP classification model to output the probability of the user being in a specific location instead of the predicted class. An initial model was modified to run further experiments. FIG. 25 illustrates the probabilities (per row) for fixed and area classifications in AE, DE, and GR with three distinct SMS transmissions/samples (i.e., 0, 1, 2), respectively. For AE and GR, the results show that the probabilities do not fall below 80%. For the specific DE area classifications in FIG. 25, the probabilities are more evenly allocated since the model cannot decisively decide the true class, especially in the first SMS trans-mission. In this case, the attacker may perform further assessments for the top two (DE-9 and DE-7) classes, or conclude that the victim might be located in one of them.

Third, the adversary can reduce the chances of unknown classes by expanding the measurement campaign to more potential locations that are not routinely tied to the victim (e.g., famous landmarks). There are research works (focusing on WiFi) that collect data from various places within cities and areas, while targeting either Access Points (APs) or smartphone devices. Additionally, the attacker can focus on utilizing areas instead of fixed positions to expand the coverage. Although this approach may not reveal the exact position (which can be translated to GPS coordinates) of the victim if the area incorporates too many positions, it allows the attacker to still track the victim without relying on the routinely fixed locations. However, the extensive data an attacker needs to collect beforehand may limit the practicality of this approach. In general, the attacker might prefer to resort to a binary decision, i.e., to determine whether or not the victim is at one of their previously seen locations, as described in the first two methods.

### Countermeasures

UE-based countermeasures. On UE devices, defenses can be implemented at the application layer or become a part of the system firmware which could be suitable for low-level cellular traffic control. There is no significant progress so far apart from Qualcomm's demonstration of rogue base station detection. On the other hand, application-based defenses elaborate on false base station detection, and on malicious SMS detection (e.g., binary, silent, etc.). RILDefender expands the SMS at-tack detection by monitoring the Radio Interface Layer.

Nonetheless, it is not considered that these detection mechanisms are applicable in this case since a false base station is not operated and the method does not solely rely on silent SMS. Measurement collection and prediction can happen through regular SMS as well. Therefore, there is currently no actual countermeasure against timing attacks. Moreover, these approaches have several other drawbacks. They lack preventive countermeasures, which means that the attack has already succeeded by the time the user is potentially alerted. Furthermore, they may rely on the user to manually block potential at-tacks, while legitimate SMS use cases could be rejected too. Practicality is further decreased as these applications cannot be supported by devices other than Android OS and specific basebands while rooting of the device is required for the application to capture and analyze the traffic. Consequently, the only countermeasures could be to either manipulate the Delivery Reports with a random delay or not send them at all.

Network-based countermeasures. Currently, no countermeasures exist to thwart location identification against a network subscriber. In fact, the network possesses neither the detection nor the prevention mechanisms to ham-per or make timing attacks unattainable. However, as a first response, the operators could disable silent SMSs across their network. Although timing attacks are still feasible, the attacker will be forced to use only regular SMSs to collect measurements and interact with the victim, which is less stealthy.

In addition, operators will need to maintain a resilient spamming/flooding filter in the core network, either in the IMS or SMSC, to capture incessant transmissions destined for a specific target. The suspicious communications can either be dropped or intentionally delayed to obstruct the attack. Nevertheless, this approach may significantly impact performance for normal users. As an alternative and more holistic countermeasure, the operators could alter all SMS timings uniformly or randomly to disrupt any side-channel analysis. This could occur during the routing and processing in IMS and SMSC. Once again, this can lead to significant performance degradation which can spread to entire networks.

Finally, a draconian but effective solution would be to eliminate Delivery Reports altogether. Nonetheless, it would necessitate considerable architectural modifications in the core network and smartphone devices (e.g., baseband modems) and re-evaluation of the specifications. Additionally, it is a challenging attempt because it would require worldwide adoption and impede the user experience, network performance testing, and commercial usage (e.g., marketing).

### Neural Network Parameter Tuning

Manual and automatic parameter tuning was utilized. For manual tuning, the main experimentation was with the neural network layers. For automatic parameter tuning the following various setups were explored:

```
Parameters: [ [
    hidden_layer_sizes: (10,40,10), (8,8,8),
      (10,10,10), (8,10,8), (10,50,10), (10,60,10)
    activation: (tanh, relu, logistic, identity)
    solver: (sgd, adam)
    alpha: (0.0001, 0.001, 0.005)
    learning_rate: (constant, adaptive)
    max_iter: (100, 200, 500, 1000, 2000, 5000)
    momentum: (0.2, 0.5, 0.7, 0.9)
  ],]
```

### SMS Timings Across Operators

Experiments are performed in AE, GR, DE, NL, BE, and LU for different locations and operators. At least 99% average accuracy for AE-2 with operators A and B, and 82% accuracy for GR-1 with operators C and D. Similarly, DE locations achieve at least 88% accuracy for E, F, and G. The dataset size for all training and prediction procedures ranges from 220 to 578 timing signatures. The plots in FIG. 25 clearly show the distinctness of delivery timings between operators in DE, GR, and AE.

Roaming cases. The remaining cases were analyzed separately due to the inclusion of measurements from roaming connections. The highest accuracy is achieved by AE-1 classification for A and C operators (Table 4). In contrast, neighboring countries such as NL, BE, and LU show less heterogeneity, with LU-1 achieving an average accuracy of 69%, and BE-1 and BE-2 reaching 61% and 66%, respectively. NL-1 and NL-4 produce scores that do not exceed 52% in the setup. It should be noted that random guessing is 33% with three classes.

### SMS Timing Across Devices

Device classifications are performed to determine if there is a distinction between devices demonstrating that UE processing is involved in timing measurements. UE processing incorporates baseband, OS, and SIM characteristics in the timings.

Six smartphones from Table 10 were used to conduct the experiments. Each was deployed at the same location with the same operator to ensure that the timings are associated with the smartphone device and cannot be influenced by the location's or network's properties. Table 5 separates the results into two sections and depicts the accuracy scores for GR and DE locations.

The first experiment was conducted in GR-1 with iPhone 6 and iPhone 7 with operator C. 300 SMS measurements were collected for each device, and the results show device identification with an accuracy of 87%. Similarly, the second part was carried out in DE-4, where operator G was used for the connections for the Google Pixel, OnePlus 7, Nokia 5.3, and Huawei P8 devices. The dataset sizes for this part were larger than the first part with 564 SMS measurements for Oneplus-Huawei, Nokia-Huawei, and Google-Huawei comparisons, 578 for Google-OnePlus, Google-Nokia comparisons, and finally 754 for OnePlus-Nokia comparison. Results show that smartphone devices can be identified with at least 99% accuracy in some cases, apart from the Huawei P8-Google Pixel and Nokia 5.3-Oneplus 7 classifications which present less diversity.

### Android Baseband Logging

The structure of the silent SMS in the Android SmsManager is defined as follows:

Next, through ADB and Logcat the SMS procedure was able to be realized at the lower layers. The command which was running during the SMS transmission was: adb logcat−b radio>radio.txt.

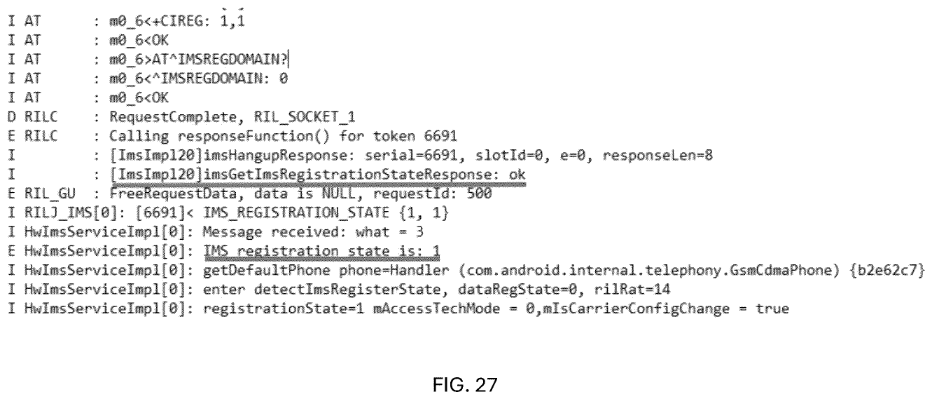

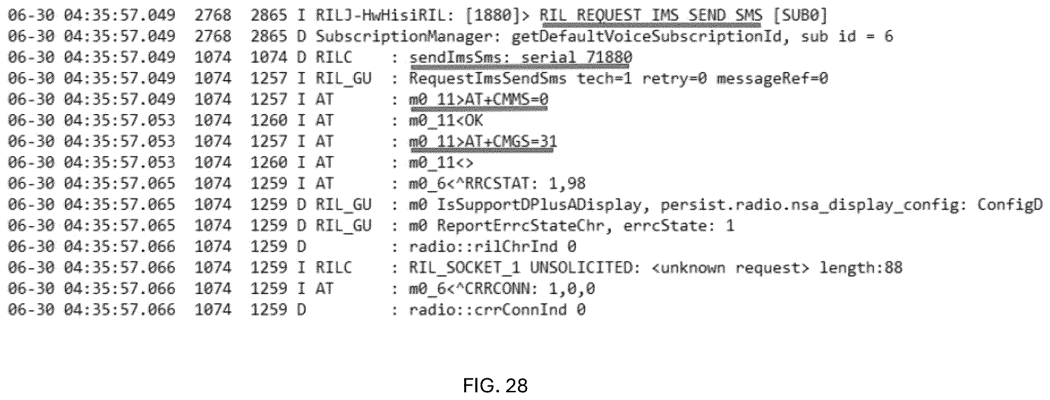

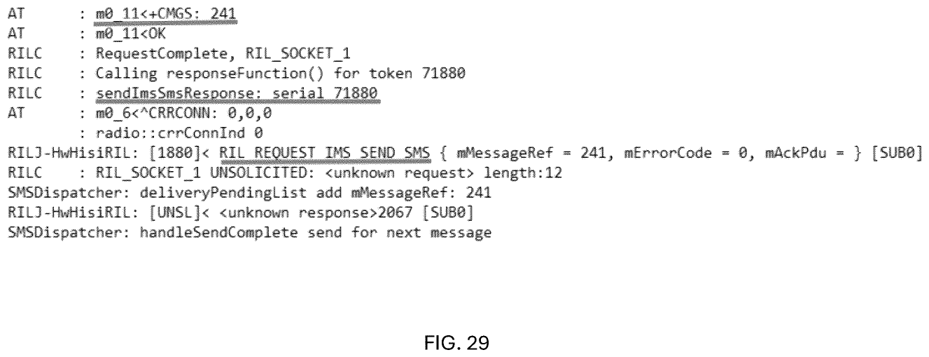

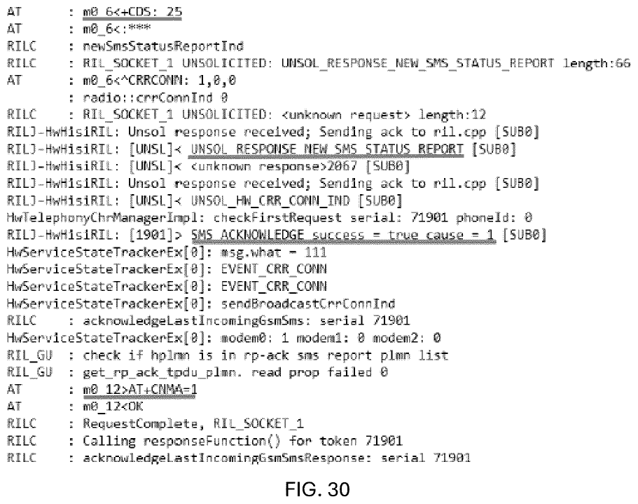

By investigating the AT commands the attacker can also collect indications about the kind of connection that is used for the SMS transmissions. FIG. 27 shows the IMS registration state prior to sending the SMS texts, which in this case is enabled. FIG. 28 presents an active device that sends an SMS through IMS (with LTE). The AT+CMMS command is used to inform the modem that several SMS messages will be sent in quick succession, and the link should be held open for more efficient transmission, but in this case it is 0 (i.e., disabled). The AT command AT+CMGS is used to send the actual SMS text and the modem responds with the message ID, i.e., 31. Then, FIG. 29 illustrates the successful delivery of the SMS text (“sent” notification) and the wait-list for the Delivery Report. Finally, FIG. 30 depicts the reception of the Delivery Report, where AT+CDS notifies us of an unsolicited delivery status in Protocol Data Unit (PDU) mode. The device responds back with an acknowledgement to Delivery Report with AT+CNMA=1, where 1 indicates the RP-ACK.

SMSoNAS vs. SMSoIP

Compared to SMSoIP, SMSoNAS has a different routing path and additional procedures that include different encryption/decryption and integrity validation processes [2, 9]. IP-based communications including SIP rely on outsourcing mechanisms for protection, even though the IMS AKA authenticates the sub-scriber. These are the IPsec and TLS which can encapsulate the payload in the network and over the transport layers respectively. On the contrary, SMS over NAS bene-fits from NAS layer protection without extra security enhancements. Consequently, these differences may cause divergent delays in the network which an adversary can capitalize on.

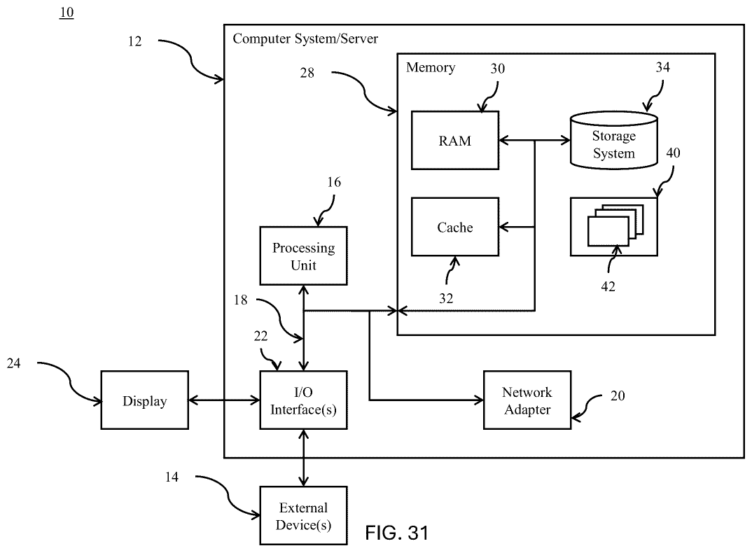

Referring now to FIG. 31, a schematic of an example of a computing node is shown. Computing node 10 is only one example of a suitable computing node and is not intended to suggest any limitation as to the scope of use or functionality of embodiments described herein. Regardless, computing node 10 is capable of being implemented and/or performing any of the functionality set forth hereinabove.

In computing node 10 there is a computer system/server 12, which is operational with numerous other general purpose or special purpose computing system environments or configurations. Examples of well-known computing systems, environments, and/or configurations that may be suitable for use with computer system/server 12 include, but are not limited to, personal computer systems, server computer systems, thin clients, thick clients, handheld or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

Computer system/server 12 may be described in the general context of computer system-executable instructions, such as program modules, being executed by a computer system. Generally, program modules may include routines, programs, objects, components, logic, data structures, and so on that perform particular tasks or implement particular abstract data types. Computer system/server 12 may be practiced in distributed cloud computing environments where tasks are performed by remote processing devices that are linked through a communications network. In a distributed cloud computing environment, program modules may be located in both local and remote computer system storage media including memory storage devices.

As shown in FIG. 31, computer system/server 12 in computing node 10 is shown in the form of a general-purpose computing device. The components of computer system/server 12 may include, but are not limited to, one or more processors or processing units 16, a system memory 28, and a bus 18 that couples various system components including system memory 28 to processor 16.

Bus 18 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, Peripheral Component Interconnect (PCI) bus, Peripheral Component Interconnect Express (PCIe), and Advanced Microcontroller Bus Architecture (AMBA).

Computer system/server 12 typically includes a variety of computer system readable media. Such media may be any available media that is accessible by computer system/server 12, and it includes both volatile and non-volatile media, removable and non-removable media.

System memory 28 can include computer system readable media in the form of volatile memory, such as random access memory (RAM) 30 and/or cache memory 32.

Computer system/server 12 may further include other removable/non-removable, volatile/non-volatile computer system storage media. By way of example only, storage system 34 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 18 by one or more data media interfaces. As will be further depicted and described below, memory 28 may include at least one program product having a set (e.g., at least one) of program modules that are configured to carry out the functions of embodiments of the disclosure.

Program/utility 40, having a set (at least one) of program modules 42, may be stored in memory 28 by way of example, and not limitation, as well as an operating system, one or more application programs, other program modules, and program data. Each of the operating system, one or more application programs, other program modules, and program data or some combination thereof, may include an implementation of a networking environment. Program modules 42 generally carry out the functions and/or methodologies of embodiments as described herein.

Computer system/server 12 may also communicate with one or more external devices 14 such as a keyboard, a pointing device, a display 24, etc.; one or more devices that enable a user to interact with computer system/server 12; and/or any devices (e.g., network card, modem, etc.) that enable computer system/server 12 to communicate with one or more other computing devices. Such communication can occur via Input/Output (I/O) interfaces 22. Still yet, computer system/server 12 can communicate with one or more networks such as a local area network (LAN), a general wide area network (WAN), and/or a public network (e.g., the Internet) via network adapter 20. As depicted, network adapter 20 communicates with the other components of computer system/server 12 via bus 18. It should be understood that although not shown, other hardware and/or software components could be used in conjunction with computer system/server 12. Examples include, but are not limited to: microcode, device drivers, redundant processing units, external disk drive arrays, RAID systems, tape drives, and data archival storage systems, etc.

The present disclosure may be embodied as a system, a method, and/or a computer program product. The computer program product may include a computer readable storage medium (or media) having computer readable program instructions thereon for causing a processor to carry out aspects of the present disclosure.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present disclosure may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present disclosure.

Aspects of the present disclosure are described herein with reference to flowchart illustrations and/or block diagrams of methods, apparatus (systems), and computer program products according to embodiments of the disclosure. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present disclosure. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

TABLE 3
Summary of regional/national classifications
within the same country.

| | All Classifications | | Best Performing | |
|---|---|---|---|---|
| Type | Num* | Avg. Acc. | Loc. Set | Accuracy |

Regional classifications with 2 locations (Random: 50%)

| | | | | |
|---|---|---|---|---|
| DE Fixed | 57 | 68% | DE-{3, 5} | 92% |
| NL Fixed | 15 | 63% | NL-{2, 3} | 98% |
| BE Fixed | 4 | 86% | BE-{1, 2} | 95% |
| DE Area | 21 | 57% | DE-{6, 8} | 72% |
| DE Mixed | 80 | 67% | DE-{8, 10} | 88% |
| NL Mixed | 4 | 71% | NL-{3, 5} | 88% |
| BE Mixed | 8 | 77% | BE-{2, 3} | 84% |
| LU Mixed | 4 | 67% | LU-{1, 3} | 72% |

Regional classification with 3 locations (Random: 33%)

| | | | | |
|---|---|---|---|---|
| AE Fixed | 1 | 76% | AE-{1, 2, 3} | 76% |
| GR Fixed | 2 | 79% | GR-{1, 2, 3} | 82% |
| DE Fixed | 46 | 54% | DE-{2, 5, 10} | 83% |
| NL Fixed | 7 | 48% | NL-{1, 2, 3} | 68% |
| DE Area | 13 | 41% | DE-{6, 7, 8} | 50% |
| DE Mixed | 252 | 50% | DE-{5, 6, 10} | 81% |
| NL Mixed | 6 | 59% | NL-{1, 3, 5} | 78% |
| BE Mixed | 4 | 67% | BE-{1, 2, 3} | 73% |

Regional classification with 4 locations (Random: 25%)

| | | | | |
|---|---|---|---|---|
| AE Fixed | 1 | 58% | AE-{1, 2, 3, 4} | 58% |
| DE Fixed | 19 | 47% | DE-{1, 2, 5, 10} | 64% |
| NL Fixed | 1 | 53% | NL-{1, 2, 3, 4} | 53% |
| DE Area | 3 | 34% | DE-{6, 7, 8, 9} | 38% |
| DE Mixed | 402 | 41% | DE-{2, 5, 9, 10} | 67% |
| NL Mixed | 4 | 48% | NL-{1, 2, 3, 5} | 58% |

Regional classification with 5 locations (Random: 20%)

| | | | | |
|---|---|---|---|---|
| DE Fixed | 3 | 37% | DE-{2, 3, 4, 5, 10} | 50% |
| DE Mixed | 398 | 34% | DE-{2, 3, 5, 8, 10} | 55% |
| NL Mixed | 1 | 42% | NL-{1, 2, 3, 4, 5} | 42% |

TABLE 4
Classification results for various operator.

| | | | |
|---|---|---|---|
| Samples | Operators | Rec. Loc. | Accuracy |

Sender Location: AE-1

| | | | |
|---|---|---|---|
| 220 | A, C | AE-1 | 100% |
| 220 | A, B | AE-2 | 99% |
| 300 | A, B | AE-3 | 100% |

Sender Location: GR-1

| | | | |
|---|---|---|---|
| 300 | C, D | GR-1 | 82% |

Sender Location: DE-4

| | | | |
|---|---|---|---|
| 511 | E, F, G | DE-3 | 94% |
| 578 | E, F, G | DE-4 | 88% |
| 889 | E, F, G | NL-4 | 51% |
| 280 | E, F, G | NL-1 | 52% |
| 313 | E, F, G | BE-1 | 61% |
| 338 | E, F, G | BE-2 | 66% |
| 257 | E, F, G | LU-1 | 69% |

TABLE 5
Device classification results for different devices.

| | iPhone | iPhone | Google | OnePlus | Nokia | Huawei |
|---|---|---|---|---|---|---|
| Devices | 12 | 7 | Pixel | 7 | 5.3 | P8 |

Sender Location: GR-1

| | | | | | | |
|---|---|---|---|---|---|---|
| iPhone 12 | — | 87% | — | — | — | — |
| iPhone 7 | 87% | — | — | — | — | — |

Sender Location: DE-4

| | | | | | | |
|---|---|---|---|---|---|---|
| Google | — | — | — | 100% | 99% | 66% |
| Pixel | | | | | | |
| Oneplus 7 | — | — | 100% | — | 53% | 100% |
| Nokia 5.3 | — | — | 99% | 53% | — | 99% |
| Huawei P8 | — | — | 66% | 100% | 99% | — |

TABLE 6
Classification accuracy for pairs of locations in
Belgium and Luxembourg.

| | |
|---|---|
| Receiver Locations | Accuracy |

Sender Location: DE-4, Operator E

| | |
|---|---|
| BE-1, BE-2 | 83% |
| BE-1, BE-3 | 80% |
| BE-2, BE-3 | 74% |
| LU-1, LU-3 | 64% |

Sender Location: DE-4, Operator F

| | |
|---|---|
| BE-1, BE-2 | 95% |
| BE-1, BE-3 | 72% |
| BE-2, BE-3 | 80% |
| LU-1, LU-3 | 66% |

Sender Location: DE-4, Operator G

| | |
|---|---|
| BE-1, BE-2 | 86% |
| BE-1, BE-3 | 84% |
| BE-2, BE-3 | 84% |
| LU-1, LU-3 | 72% |

TABLE 7
Multi-class classification tasks between fixed
positions for AE and GR.

| | | |
|---|---|---|
| Samples | Receiver Locations | Accuracy |

Sender Location: AE-1, Operator: A

| | | |
|---|---|---|
| 300 | AE-1, AE-2, AE-3, AE-4 | 58% |
| 300 | AE-1, AE-2, AE-3 | 76% |

Sender Location: GR-1, Operator: C

| | | |
|---|---|---|
| 300 | GR-4, GR-5, GR-6 | 76% |
| 300 | GR-1, GR-2, GR-3 | 82% |

TABLE 8
Classification accuracy for pairs of fixed
locations and areas in the Netherlands.

| | | | |
|---|---|---|---|
| NL-2 | NL-3 | NL-4 | NL-5 |

Sender Location: DE-4, Operator: E

| | | | |
|---|---|---|---|
| NL-1 | | 60% | 52% |
| NL-2 | — | | |
| NL-3 | — | — | 52% |
| NL-4 | — | — | — |

Sender Location: DE-4, Operator: F

| | | | |
|---|---|---|---|
| NL-1 | | 50% | 48% |
| NL-2 | — | | |
| NL-3 | — | — | 54% |
| NL-4 | — | — | — |

Sender Location: DE-4, Operator: G

| | | | | |
|---|---|---|---|---|
| NL-1 | 62% | 92% | 49% | 68% |
| NL-2 | — | 98% | 61% | 58% |
| NL-3 | — | — | 88% | 88% |
| NL-4 | — | — | — | 70% |

TABLE 9
Classification accuracy for pairs of
fixed locations and areas in Germany.

| | | | | DE- | | | | |
|---|---|---|---|---|---|---|---|---|
| DE-2 | DE-3 | DE-4 | DE-5 | 10 | DE-6 | DE-7 | DE-8 | DE-9 |

Sender Location: DE-4, Operator: E

| | | | | | | | | | |
|---|---|---|---|---|---|---|---|---|---|
| DE-1 | 74% | | 63% | | 79% | 63% | | | |
| DE-2 | — | 77% | 62% | 74% | 65% | 68% | 73% | 60% | 62% |
| DE-3 | — | — | 87% | 76% | 72% | 86% | 44% | 54% | 62% |
| DE-4 | — | — | — | 75% | 67% | 55% | 53% | 64% | 57% |
| DE-5 | — | — | — | — | 72% | 74% | 73% | 77% | 63% |
| DE-10 | — | — | — | — | — | 64% | 61% | 56% | 66% |
| DE-6 | — | — | — | — | — | — | 57% | 62% | 56% |
| DE-7 | — | — | — | — | — | — | — | 63% | 58% |
| DE-8 | — | — | — | — | — | — | — | — | 46% |

Sender Location: DE-4, Operator: F

| | | | | | | | | | |
|---|---|---|---|---|---|---|---|---|---|
| DE-1 | | 82% | 58% | 56% | | | 74% | 74% | 60% |
| DE-2 | — | | | | | | | | |
| DE-3 | — | — | 67% | 76% | | | 60% | 52% | 66% |
| DE-4 | — | — | — | 64% | | | 67% | 62% | 52% |
| DE-5 | — | — | — | — | | | 70% | 82% | 68% |
| DE-10 | — | — | — | — | — | | | | |
| DE-6 | — | — | — | — | — | — | | | |
| DE-7 | — | — | — | — | — | — | — | 62% | 54% |
| DE-8 | — | — | — | — | — | — | — | — | 51% |

Sender Location: DE-4, Operator: G

| | | | | | | | | | |
|---|---|---|---|---|---|---|---|---|---|
| DE-1 | 81% | | 78% | 50% | 86% | 74% | 70% | 70% | 68% |
| DE-2 | — | 62% | 56% | 82% | 91% | 64% | 75% | 88% | 78% |
| DE-3 | — | — | 61% | 92% | 82% | 52% | 61% | 77% | 72% |
| DE-4 | — | — | — | 82% | 84% | 68% | 50% | 84% | 74% |
| DE-5 | — | — | — | — | 86% | 81% | 72% | 81% | 70% |
| DE-10 | — | — | — | — | — | 76% | 83% | 88% | 84% |
| DE-6 | — | — | — | — | — | — | 58% | 72% | 58% |
| DE-7 | — | — | — | — | — | — | — | 58% | 62% |
| DE-8 | — | — | — | — | — | — | — | — | 52% |

TABLE 10
Device Specifications. Except from Google Pixel 4 XL which used eSIM, all devices were equipped
with physical SIM cards. The attack worked on all tested smartphones.

| Device | Modem | OS | Model | Release |
|---|---|---|---|---|
| Apple iPhone 13 | Qualcomm Snapdragon X60 | iOS 15 | A2633 | 2021 |
| One Plus Nord 2.5G | MediaTek Dimensity 1200 5G | Android 11 | DN2101 | 2021 |
| Alcatel 1S | Spreadtrum UNISOC SC9863 | Android 11 | 6025D | 2021 |
| Apple iPhone 12 mini | Qualcomm X55 modem | iOS 15 | A2399 | 2020 |
| Nokia 8.3 5G | Snapdragon 765G 5G | Android 10 | TA-1243 | 2020 |
| Apple iPhone 12 | Qualcomm Snapdragon X55 | iOS 15 | A2403 | 2020 |
| Samsung Galaxy A21S | Samsung Exynos 850 | Android 10 | SM-A217P | 2020 |
| Huawei P40 Pro 5G | HiSilicon Kirin 990 5G | Android 10 | ELS-NX9 | 2020 |
| Nokia 5.3 | Qualcomm Snapdragon 665 | Android 11 | TA-1234 | 2020 |
| Google Pixel 4 XL | Qualcomm Snapdragon X24 | Android 12 | G020I | 2019 |
| OnePlus 7 Pro | Qualcomm Snapdragon 855 | Android 11 | GM1910 | 2019 |
| Google Pixel 3a | Qualcomm Snapdragon 670 | Android 11 | G020F | 2019 |
| Samsung Note 10 5G | Samsung Exynos 9825 | Android 10 | SM-N976Q | 2018 |
| Huawei P8 Lite 2017 | HiSilicon Kirin 655 | Android 10 | PRA-LA1 | 2017 |
| Apple iPhone 7 | Intel XMM7360 | iOS 15 | A1778 | 2016 |
| Apple iPhone 5 | Qualcomm MDM9615M | iOS 10 | A1428 | 2013 |

TABLE 11
Number of SMS received in our experiments. The [symbol] denotes a sender device only.

| Device | Countries and Operators | | | | | | | | |
|---|---|---|---|---|---|---|---|---|---|
| Int'l, Nat. & Reg. | AE | | | OR | | UK | US | DE | DK |
| (Sections [symbol] & [symbol] ) | A | B | C | C | D | H | J | E | I |
| Apple iPhone 13 | 0 | 0 | 0 | 350 | 0 | 0 | 0 | 0 | 0 |
| One Plus Nord 2 5G | 350 | 350 | 0 | 0 | 0 | 0 | 0 | 0 | 0 |
| Alcatel IS | 0 | 0 | 0 | 350 | 0 | 0 | 0 | 0 | 0 |
| Apple iPhone 12 mini | 350 | 350 | 0 | 0 | 0 | 0 | 0 | 0 | 0 |
| Nokia 8.3 5G | 350 | 350 | 0 | 0 | 0 | 0 | 0 | 0 | 0 |
| Apple iPhone 12 | 0 | 0 | 0 | 350 | 350 | 350 | 0 | 0 | 0 |
| Samsung Galaxy A21S | 0 | 0 | 0 | 350 | 0 | 0 | 0 | 0 | 0 |
| Huawei P40 Pro 5G* | 0 | 0 | 0 | 0 | 0 | 0 | 0 | 0 | 0 |
| Google Pixel 4 XL | 0 | 0 | 0 | 0 | 0 | 0 | 350 | 0 | 0 |
| Samsung Note 10 5G | 350 | 350 | 0 | 0 | 0 | 0 | 0 | 0 | 0 |
| Apple iPhone 7 | 0 | 0 | 0 | 700 | 0 | 0 | 0 | 0 | 350 |
| Apple iPhone 5 | 0 | 0 | 350 | 0 | 0 | 0 | 0 | 0 | 0 |
| OnePlus 7 Pro | 0 | 0 | 0 | 0 | 0 | 0 | 0 | 350 | 0 |

| Nat. & Reg. | BE | | | DE | | | LU | | | NL | | |
|---|---|---|---|---|---|---|---|---|---|---|---|---|
| (Secton [symbol] ) | E | F | G | E | F | G | E | F | G | E | F | G |
| Nokia 5.3 | 0 | 0 | 798 | 1350 | 0 | 3159 | 0 | 0 | 455 | 0 | 0 | 1419 |
| OnePlus 7 Pro | 0 | 0 | 839 | 2021 | 0 | 3109 | 0 | 0 | 422 | 0 | 0 | 1411 |
| Google Pixel 3a | 0 | 818 | 0 | 1963 | 2516 | 1092 | 0 | 499 | 0 | 0 | 1399 | 0 |
| Huawei P8 Lite 2017 | 804 | 0 | 0 | 3342 | 1111 | 1153 | 513 | 0 | 0 | 1416 | 0 | 0 |
| Temporal & Network | | | | DE | | | | | | NL | | |
| (Sections [symbol] & [symbol] ) | | | | E | F | G | | | | E | F | G |
| Huawei P8 Lite 2017 | | | | 14132 | 0 | 0 | | | | 15607 | 0 | 0 |
| OnePlus 7 Pro | | | | 0 | 0 | 16625 | | | | 0 | 0 | 12799 |
| Google Pixel 6a | | | | 0 | 14752 | 0 | | | | 0 | 16115 | 0 |
| Samsung Galaxy A53 | | | | 0 | 0 | 11095 | | | | 0 | 0 | 15778 |

[symbol]

indicates data missing or illegible when filed

TABLE 12
Classification results for international experiments.

| Classification | Size/Class | Operators | Receiver Locations | Sender Location | Accuracy |
|---|---|---|---|---|---|
| Overseas-vs.-Domestic | 1200 | A, C, E, H, I, J | AE-X, Int-X | AE-1 | 96% |
| All Country-based | 280 | C, E, H, I, J | Int-X | AE-1 | 96% |
| EU Country-based | 280 | C, E, I | Int-GR, Int-DE, Int-DK | AE-1 | 95% |
| EU Country-based | 257 | G | DE-4, NL-4, BE-1, LU-1 | DE-4 | 75% |
| EU Country-based | 319 | E | DE-4, NL-4, BE-1, LU-1 | DE-4 | 74% |
| EU Country-based | 313 | F | DE-4, NL-4, BE-1, LU-1 | DE-4 | 62% |

What is claimed is:

1. A method, comprising:
sending a short message service (SMS) to a target device, via a short message service center (SMSC);
receiving, from the target device, a delivery report based on the sent SMS through the SMSC;
providing the delivery report as an input to a pretrained machine learning model;
deriving one or more fingerprints from the delivery report, thereby creating a target data model based on the one or more fingerprints;
predicting, based on the target data model, a location of the target device.

2. The method of claim 1, wherein the delivery report is triggered by receipt of the SMS at the target device.

3. The method of claim 1, wherein the delivery report comprises one or more delays from the target device.

4. The method of claim 3, wherein the one or more delays comprise a processing delay, a routing delay, and/or a propagation delay.

5. The method of claim 1, wherein the trained machine learning model is an artificial neural network.

6. The method of claim 5, wherein the artificial neural network is a multilayer perceptron classifier.

7. The method of claim 1, wherein the one or more fingerprints comprise a time delay based on the target device location.

8. The method of claim 1, further comprising sending a plurality of SMSs to the target device from a plurality of locations.

9. The method of claim 1, wherein the target device location is stationary.

10. The method of claim 1, wherein the target device location is dynamic.

11. The method of claim 1, wherein the pretrained machine learning model is trained on a dataset of fingerprints of known locations of target devices.

12. A system comprising:
a short message service center (SMSC); and
a mobile device, wherein:
the mobile device is configured to receive a short message service (SMS) from the SMSC;
the mobile device is configured to send a delivery report based on the sent SMS to the SMSC;
the SMSC is configured to receive the delivery report;
the SMSC is configured to provide the delivery report as an input to a pretrained machine learning model;
the pretrained machine learning model is configured to deriving one or more fingerprints from the delivery report, thereby creating a target data model based on the one or more fingerprints;
the pretrained machine learning model is configured to predict, based on the target data model, a location of the target device.

13. A system comprising:
a computing node comprising a computer readable storage medium having program instructions embodied therewith, the program instructions executable by a processor of the computing node to cause the processor to perform a method comprising:
sending a short message service (SMS) to a target device, via a short message service center (SMSC);
receiving, from the target device and through the SMSC, a delivery report;
providing the delivery report as an input to a pretrained machine learning model;
deriving one or more fingerprints from the delivery report, thereby creating a target data model based on the one or more fingerprints;
predicting, based on the target data model, a location of the target device.

14. The system of claim 13, wherein the delivery report is triggered by receipt of the SMS at the target device.

15. The system of claim 13, wherein the delivery report comprises one or more delays from the target device.

16. The system of claim 15, wherein the one or more delays comprise a processing delay, a routing delay, and/or a propagation delay.

17. The system of claim 13, wherein the trained machine learning model is an artificial neural network.

18. The system of claim 17, wherein the artificial neural network is a multilayer perceptron classifier.

19. The system of claim 13, wherein the one or more fingerprints comprise a time delay based on the target device location.

20. A computer program product, the computer program product comprising a computer readable storage medium having program instructions embodied therewith, the program instructions executable by a processor to cause the processor to perform a method comprising:
sending a short message service (SMS) to a target device, via a short message service center (SMSC);
receiving, from the target device and through the SMSC, a delivery report;
providing the delivery report as an input to a pretrained machine learning model;
deriving one or more fingerprints from the delivery report, thereby creating a target data model based on the one or more fingerprints;
predicting, based on the target data model, a location of the target device.
